(19) United States
(12) Patent Application Publication
(10) Pub. No.: US 2026/0301033 A1
(43) Pub. Date: Oct. 1, 2026

(54) METHOD AND SYSTEM OF REAL TIME VALUATION OF UNMINED GOLD DEPOSITS FOR TOKENIZATION

(71) Applicant: NatGold Digital Ltd., Miami, FL (US)

(72) Inventor: Anthony Wade Wile, Carson City, NV (US)

(21) Appl. No.: 19/576,467

(22) Filed: Mar. 24, 2026

Related U.S. Application Data
(60) Provisional application No. 63/794,674, filed on Apr. 25, 2025.
(60) Provisional application No. 63/794,662, filed on Apr. 25, 2025.
(60) Provisional application No. 63/777,379, filed on Mar. 25, 2025.
(60) Provisional application No. 63/777,373, filed on Mar. 25, 2025.

(51) Int. Cl. G06Q 30/0283; G06Q 50/02

(52) U.S. Cl. CPC G06Q 30/0283; G06Q 50/02

(57) ABSTRACT

A computer-implemented method for determining a valuation for the tokenizing of verified unmined gold deposits. The systems and methods include receiving, via a graphical user interface, proof of title documentation for an unmined gold deposit. Resource verification documentation compliant with at least one regulatory standard corresponding to the unmined gold deposit is received. A real-time All-In Sustaining Cost (AISC) index that provides a continuously updated weighted global average of gold production costs is accessed. A net present value associated with the unmined gold deposit is calculated based at least in part on the real-time AISC index. Based on the net present value, a total quantity of distributable tokens is determined. A set of distributed tokens representing fractional interests of the net present value is issued. The issuance of the set of distributed tokens is recorded in a distributed ledger maintained across a set of validating nodes.

### CROSS-REFERENCE TO RELATED APPLICATIONS

This application claims the benefit of U.S. Provisional Application No. 63/777,373, titled “Real Time Mining Index System Method and Apparatus,” filed on Mar. 25, 2025, U.S. Provisional Application No. 63/777,379, titled “Method and System of Real Time Valuation of Unmined Gold Deposits for Tokenization,” filed on Mar. 25, 2025, U.S. Provisional Application No. 63/794,662, titled “System and Method and Apparatus for Creating a Digital Cutoff Grade,” filed on Apr. 25, 2025, and U.S. Provisional Application No. 63/794,674, titled “System, Method, and Apparatus for Tokenizing Unmined Gold Deposits Using a Digital Cutoff Grade,” filed on April 25, 2025, the entire disclosures of which are hereby incorporated by reference herein.

### BACKGROUND

Traditional methods of representing and trading unmined mineral assets, particularly gold deposits, have faced challenges. The mining industry has struggled with creating reliable digital representations of physical assets that meet rigorous verification standards while maintaining regulatory compliance. Current systems often lack integration between physical resource management and digital trading platforms, making it difficult to track and verify mining activities against digital representations. Additionally, existing solutions have not adequately addressed the growing need for environmental consideration tracking and verification in mining operations.

The industry has also faced persistent challenges in transaction security and access rights management when dealing with representations of unmined assets. Traditional trading systems often lack mechanisms for protecting participants during digital asset exchanges and fail to provide adequate frameworks for managing and verifying mining access rights. Furthermore, the absence of standardized methods for incorporating environmental, social, and governance (ESG) considerations into digital trading platforms has created obstacles for responsible resource management.

### BRIEF SUMMARY

Aspects of the present application are directed to a system configured to implement processes relating to providing a secure, legally compliant, and environmentally conscious system for representing and trading unmined gold deposits in a digital realm (herein referred to as an “asset management system”). According to embodiments, the asset management system provides secure, verified digital representation of unmined gold deposits while maintaining regulatory compliance and environmental consciousness. Advantageously, the asset management system addresses challenges in the digitization and trading of unmined gold deposits by implementing verification standards (e.g., NI 43-101, S-K 1300) in representing physical gold deposits in digital form to ensure that resource estimates are properly authenticated by qualified persons, and integrating a cost index associated with asset mining operations that is updated in real-time (also referred to as the “All-In Sustaining Cost (AISC)” index) for accurate economic valuation of the unmined assets.

According to embodiments, the cost index management system is configured to generate a cost index associated with asset mining operations. According to embodiments, the asset management system enables resource management through a framework for managing access rights to mining deposits through a real-time cost index (e.g., the real-time AISC index). According to embodiments, the asset management system addresses environmental concerns through direct integration of Environmental, Social, and Governance (ESG) compliance tracking within the smart contract infrastructure, helping ensure mining operations credits aligned with environmental standards. According to embodiments, the asset management system further resolves security concerns inherent in digital asset trading through innovative transaction mechanisms and multi-signature validation protocols, protecting participants during token exchanges. According to embodiments, the asset management system provides a secure, legally compliant, and environmentally conscious system for representing and trading unmined gold deposits in the digital realm.

According to embodiments, the asset management system uses the real-time cost index to generate a continuously updated weighted global average of gold production costs, creating an unprecedented level of valuation accuracy for unmined deposits. According to embodiments, the asset management system addresses environmental concerns through direct integration of ESG tracking within the smart contract infrastructure, helping ensure mining operations credits aligned with environmental standards. By correlating ESG performance with cost metrics (e.g., AISC metrics), the asset management system incentivizes sustainable practices that reduce production costs. The asset management system also resolves security concerns inherent in digital asset trading through innovative transaction mechanisms and multi-signature validation protocols, protecting participants during token exchanges. Through its real-time AISC index integration, the asset management system maintains dynamic token valuations that accurately reflect changing industry economics, providing unprecedented transparency and trust in unmined gold asset tokenization. Advantageously, the asset management system addresses and overcomes a number of problems associated with conventional approaches by providing a secure, legally compliant, economically accurate, and environmentally conscious system for representing and trading unmined gold deposits in the digital realm.

### BLOCKCHAIN AND RELATED TERMS

"artifact" means a self-contained piece of digital content that can be referenced and updated throughout a blockchain system.

"blockchain" refers to a distributed, immutable ledger that records transactions across a network of computers.

"consensus mechanism" refers to the protocol by which the network reaches agreement on the valid state of the blockchain.

"deep web network address" means a network location that cannot be indexed by web search engines.

"distributed ledger" means a consensus of replicated, shared, and synchronized digital data.

"hash" means a function that converts an input of data into a fixed-size string of text.

"mining" means validating and adding new transactions to the blockchain through computation.

"network interface" means a software or hardware interface between network sections.

"node" refers to a computer or device that participates in the blockchain network.

"permissioned blockchain" means a blockchain where only selected participants can validate.

"private key" means a secret number that allows cryptocurrency transactions to be signed.

"public key" refers to a cryptographic code that allows users to receive cryptocurrency transactions.

"smart contract" means self-executing contracts written into code on the blockchain.

"token" means a digital asset created and managed on the blockchain.

"transaction wallet" means a temporary digital wallet created for a specific transaction.

"user wallet address" means an alphanumeric code for receiving and transmitting transactions.

"wallet" refers to software that allows users to store and manage their private keys.

### GOLD DEPOSIT AND RESOURCE TERMS

"assay" refers to testing of metal or ore to determine ingredients and quality.

"core sample" means a cylindrical section of rock obtained by drilling.

"cut-off grade" means the minimum grade of economically mineable mineralization.

"grade" means the concentration of gold within the ore.

"geophysical survey" means using physical methods to measure rock properties.

"metallurgical recovery" means the percentage of gold extractable from ore.

"NI 43-101" refers to Canadian standards for reporting mineral properties.

"physical mining" means extraction and processing of mineral resources.

"probable reserves" means the economically mineable part of an Indicated Resource

"proven reserves" means the economically mineable part of a Measured Resource

"qualified person" means a professional credentialed to validate resource estimates.

"resource classification" means systematic categorization of mineral resources.

"resource estimate" means professional assessment of deposit quantity and grade.

"resource verification documentation" means official validation of mineral resources.

"S-K 1300" means the SEC's mining property disclosure requirements.

"strike length" means the longest horizontal dimension of an ore body.

"unmined gold deposit" means a natural concentration of gold-bearing material.

### ENVIRONMENTAL, SOCIAL, AND GOVERNANCE (ESG) TERMS

### Environmental Terms

"biodiversity impact" means the effect on local flora and fauna.

"carbon footprint" means total greenhouse gas emissions from mining activities.

"environmental baseline" means initial environmental conditions.

"environmental preservation requirements" means obligations to maintain environments.

"environmental risk assessment" means evaluation of potential impacts.

"preservation value" means ecological worth of maintaining natural state.

"water management" means strategies for protecting water resources.

### Social Terms

"community development agreement" means formal agreements with local communities.

"community impact" means effect on local communities and indigenous peoples.

"cultural heritage" means archaeological, historical, or cultural significance.

"indigenous rights" means rights of indigenous peoples regarding land.

"social license" means level of acceptance by local communities.

"stakeholder engagement" means process of involving relevant parties.

### Governance Terms

"Environmental, Social, and Governance (ESG) compliance" means adherence to environmental, social, and governance standards.

"ESG crediting system" means system for tracking ESG compliance.

"ESG reporting standards" means frameworks for ESG disclosure.

"regulatory oversight" means governance structure ensuring compliance.

"resource verification systems" means technologies for validating resources.

"stakeholder rights" means established rights of interested parties.

"Sustainable Development Goals" means the UN's global goals.

"Transparency Framework" means system for reporting ESG information.

### DIGITAL ESG INTEGRATION TERMS

"digital signature authorization" means cryptographic validation of rights transfer.

"ESG smart contract" means blockchain contracts encoding ESG requirements.

"ESG token attributes" means ESG characteristics embedded in tokens.

"impact verification oracle" means third-party ESG compliance data sources.

"real-time operational monitoring" means continuous tracking of metrics.

"sustainability metrics" means quantifiable ESG indicators.

"token burning protocol" means process for removing tokens from circulation.

### BRIEF DESCRIPTION OF THE FIGURES

To easily identify the discussion of any particular element or act, the most significant digit or digits in a reference number refer to the figure number in which that element is first introduced.

FIG. 1 is an example network diagram showing technical infrastructure of a networked computing environment supporting an asset management system for the tokenization and trading of unmined gold deposit rights, including application servers, web interfaces, and database systems, according to one or more embodiments.

FIG. 2A is a flow chart illustrating an example process for determining and tokenizing a value of verified unmined gold deposits, according to one or more embodiments.

FIG. 2B is a flow chart illustrating an example process for tokenizing verified unmined gold deposits, according to one or more embodiments.

FIG. 3 is a flow chart showing an example process for secure transfer of blockchain tokens representing interests in unmined gold deposits, including steps for displaying deposit information, receiving exchange orders, and processing token transfers, according to one or more embodiments.

FIG. 4 is a flow chart depicting an example process for calculating and displaying token quantities corresponding to cryptographic currency values based on exchange rates for unmined gold deposit tokens, according to one or more embodiments.

FIG. 5 is a flow chart illustrating an example process for converting specified quantities of blockchain tokens representing unmined gold deposits into corresponding cryptographic currency values using current exchange rates, according to one or more embodiments.

FIG. 6 is a flow chart showing an example process for executing secure exchanges between cryptographic currency and blockchain tokens representing unmined gold deposits through deep web transaction mechanisms, according to one or more embodiments.

FIG. 7 is a flow chart depicting an example process for obtaining and managing access rights to unmined gold deposits through token-based smart contracts, including steps for identity verification and environmental compliance, according to one or more embodiments.

FIG. 8 is an architectural diagram illustrating an example distributed electronic ledger system incorporating multiple validation nodes and consensus mechanisms for maintaining the integrity of unmined gold deposit token transactions, according to one or more embodiments.

FIG. 9 is a flow chart depicting an example process for determining a valuation and tokenizing verified unmined assets (e.g., unmined gold deposits) using a real-time cost index, according to one or more embodiments.

FIG. 10 is a diagram illustrating example components and architecture of a computing system implementing the tokenization and trading functionality, including processors, memory systems, and input/output (I/O) components, according to one or more embodiments.

FIG. 11 illustrates a flow chart depicting an example process relating to a real time index-based valuation and tokenization of unmined deposits, according to one or more embodiments.

### DETAILED DESCRIPTION

The disclosed technology encompasses blockchain systems, distributed ledger methodologies, and/or computer program commodities at varying degrees of technical integration (herein referred to as an “asset management system”). Such a computer program commodity may comprise a machine-readable storage medium (or multiple mediums) bearing machine-executable instructions to prompt a processor to execute components of the specified blockchain technology, including smart contracts, token creation, and distributed consensus mechanisms.

Aspects of the present disclosure are related to a computer-implemented system (the asset management system) for tokenizing verified assets (e.g., unmined gold deposits) by transforming physical asset documentation into standardized blockchain-based digital tokens. According to embodiments, the asset management system employs machine learning models and automated processing algorithms to validate proof of title, verify resource documentation compliant with regulatory standards (e.g., NI 43-101 and/or S-K 1300), and calculate distributable token quantities based on geological data and risk assessment factors. Through smart contract generation and distributed ledger technology, the asset management system creates fungible digital tokens that represent fractional interests in verified gold deposits, with each token incorporating standardized unit values and embedded contractual terms for secure transfer and ownership management. The asset management system addresses technical challenges in digital asset representation by providing automated, scalable processes that ensure regulatory compliance, maintain data integrity through cryptographic validation, and enable secure trading of unmined mineral asset rights in a digital environment.

According to embodiments, the asset management system includes machine-readable medium which is a physical entity capable of maintaining and storing instructions to be utilized by an instruction execution apparatus, including blockchain nodes, mining equipment, and validation systems. The medium could be, for example, but not restricted to, electronic, magnetic, optical, electromagnetic, semiconductor storage devices, or a fusion of these. A non-limiting list of specific instances of the machine-readable medium includes portable computer diskettes, hard drives, RAM, ROM, EPROM or Flash memory, SRAM, CD-ROMs, DVDs, memory sticks, floppy disks, and mechanical devices like punch-cards or tangible structures with instructions. It should be clarified that the aforementioned medium does not consider transitory signals in isolation, like free-propagating electromagnetic waves or electrical signals over wires.

The machine-executable instructions detailed can be transferred to diverse computational devices, including blockchain nodes and mining systems, from the machine-readable medium or an external computer or storage via networks like the Internet, LANs, WANs, or wireless networks. Such networks may integrate copper or optical fibers, wireless transmission mechanisms, routers, firewalls, switches, gateway computers, and edge servers. Within each computational device, a network interface or adapter fetches the instructions from the network, forwarding them for retention in the device's machine-readable medium and blockchain ledger.

Instructions facilitating blockchain operations of this technology might be encoded as smart contracts, consensus algorithms, mining protocols, or code (both source and object) in diverse programming languages. Examples include but aren't restricted to blockchain-specific languages like Solidity, as well as object-oriented languages like Python, Java, C++, and procedural ones like the "C" language. These instructions might operate wholly on a local blockchain node, partly on local and remote nodes, or entirely across the distributed network. Remote nodes can be linked via peer-to-peer networks, inclusive of the Internet via ISPs. In certain cases, specialized mining hardware such as ASICs or GPUs could employ the instructions, utilizing their state data to actualize facets of the blockchain technology.

Aspects of the present disclosure are described herein with reference to flowcharts and block diagrams of methods, systems, and computer program products per its blockchain solution variants. Each block in these can be realized via machine-executable instructions, including smart contracts and consensus mechanisms, executable by an asset management system, according to embodiments of the present disclosure.

According to embodiments, the instructions may be presented to a processor in general-purpose computers, specialized mining computers, or other programmable data apparatuses of the asset management system, to enable execution of the functions and operations denoted in the diagrams. Furthermore, according to embodiments, the instructions may be conserved, maintained, or stored within a distributed ledger directing nodes to operate in a specific fashion. According to embodiments, the instructions could also be loaded onto a blockchain node or mining device to prompt a sequence of tasks producing a blockchain-driven process.

The depicted flowcharts and diagrams exhibit example embodiments of asset tokenization management, related processes or methods, and product architectures and functionalities per the technology's blockchain solution variants. According to embodiments, the processes of the asset management system, may be implemented by specialized blockchain systems designed for those tasks or combinations of hardware and machine instructions.

For the purposes of this application when referencing NI 43-101 (Canadian) and S-K 1300 (US) standards, these are National regulatory standards for reporting mineral resources and reserves.

According to embodiments, the asset management system implements processes including features and operations relating to resource classification including inferred resource classification (e.g., lowest confidence level, based on limited sampling and geological evidence), indicated resource classification (e.g., moderate confidence, supported by adequately spaced sampling and testing), and measured resource classification (e.g., highest confidence, based on detailed and reliable exploration, sampling, and testing.

According to embodiments, the asset management system implements processes including features and operations relating to reserve classification (e.g., associated with economically mineable deposits) including probable reserves (e.g., reserves derived from indicated and/or measured resources) and proven reserves (e.g., derived from measured resources only).

According to embodiments, the asset management system is configured to implement one or more valuation methods to generate valuations for resources and reserves which integrates multiple components or factors to determine the economic value of mineral deposits. According to embodiments, resource confidence levels serve as the basis for valuation, with each resource classification type or level receiving a specific risk-adjusted multiplier to reflect one or more aspects or parameters, such as, for example, geological certainty.

In an embodiment, the asset management system integrates the use of the All-In Sustaining Cost (AISC) as established by the World Gold Council, which provides a standardized framework for understanding the true costs of gold production. In an embodiment, the asset management system enhances this established metric through the Real-Time AISC Index, which delivers continuously updated weighted global averages of production costs by incorporating the latest data as reported by individual mining companies.

In an embodiment, one or more economic parameters may be employed in generating the valuation. In an embodiment, the economic parameters may include or incorporate the cost metric index (e.g., the Real-Time AISC Index) along with commodity price forecasts spanning the projected mine life, access to the minerals considerations, and capital expenditure requirements for development and sustaining operations, etc.

According to embodiments, the valuation may include one or more technical factors. In an embodiment, the technical factors may include or consider one or more of metallurgical recovery rates based on test work, mining dilution derived from geotechnical studies, and processing costs determined through engineering studies. In an embodiment, the valuation may include jurisdictional considerations such as the evaluation of royalty structures, taxation regimes, and permitting timeline impacts on project economics. In an embodiment, the valuation may include market comparable analysis which examines similar deposits in terms of one or more factors including grade, tonnage, jurisdiction, etc. to validate valuations against transaction data.

According to embodiments, the valuation calculation method may include verification of base resource and reserve tonnages and grades through qualified person review. In an embodiment, the valuation calculation method may include the consideration of technical modifying factors that are applied to account for one or more factors such as mining recovery, dilution, processing performance, etc. According to embodiments, the valuation calculation method may include an estimation of operating and capital costs, incorporating one or more capital-related costs relating to equipment, labor, consumables, infrastructure requirements, etc., all benchmarked against the current Real-Time AISC Index.

According to embodiments, the asset management system develops revenue projections using commodity price forecasts that consider market cyclicality and trends. By analyzing the spread between projected gold prices and the Real-Time AISC Index over the project lifecycle, the asset management system calculates expected profit margins. According to embodiments, the asset management system generates risk-adjusted net present value calculations incorporate discount rates reflecting project stage and jurisdiction. The process incorporates a comparable transaction analysis to validate the calculated valuations against market precedents.

According to embodiments, the valuation calculation method may include resource and revenue projections that are developed using commodity price forecasts that consider market cyclicality and trends. In an embodiment, resource and reserve valuations undergo continuous updates to maintain accuracy and market relevance. Unlike traditional valuation models that rely on periodic reassessment, the asset management system integrates with the Real-Time AISC Index to enable valuation adjustments in real time. When the AISC Index reflects significant changes in global production costs, smart contracts automatically recalibrate token values to maintain economic accuracy.

According to embodiments, the valuation calculation method may include the use of technical reports and resource estimates that are updated to reflect new drilling, sampling, and geological interpretation. According to embodiments, the valuation calculation method may include commodity price forecasts that are revised based on market conditions and industry consensus. According to embodiments, the valuation calculation method may include market transactions that are analyzed to validate valuation parameters. According to embodiments, the valuation calculation method may include operating cost assumptions that are adjusted for inflation, technological changes, and efficiency improvements. According to embodiments, the valuation calculation method may include the consideration of jurisdictional factors that may be reassessed as regulatory and fiscal regimes change, update, and/or evolve. According to embodiments, the valuation calculation method may include updates that are validated by one or more qualified persons before being reflected in token smart contracts through, for example, oracle-based price feeds.

According to embodiments, the token architecture may be implemented by the asset management system through a series of smart contracts deployed on an enterprise-grade blockchain platform. According to embodiments, these contracts encode the relationship between physical claims and digital tokens, incorporating resource documentation further comprising the use of smart contracts that reference authenticated NI 43-101 or S-K 1300 technical reports and current AISC index values, storing claim coordinates and resource estimates on-chain. According to embodiments, each token maintains a reference to the Real-Time AISC Index, enabling automatic recalibration as production economics evolve. Claim coordinates and resource estimates are stored on-chain, and are updatable only by authorized Qualified Persons through protocols that confirm their authenticity. According to embodiments, these resources are updatable by authorized qualified persons through protocols that confirm the authenticity of the qualified persons. According to embodiments, implementation of on-chain KYC/AML verification may be managed through integration with established compliance providers.

According to embodiments, the asset management system can be configured to employ a tokenized warehouse receipt form or format which represents a standardized digital format of a traditional warehouse receipt, adapted specifically for unmined gold deposits. Similar to how agricultural commodities use warehouse receipts under USDA frameworks, tokenized warehouse receipts for unmined gold deposits provide a legally recognized structure for representing ownership rights of verified underground resources while maintaining physical preservation of the deposit.

Advantageously, the use of digital receipts operate under established legal frameworks, particularly Uniform Commercial Code (UCC) Article 7, which governs documents of title including warehouse receipts. According to embodiments, the adaptation of this traditional structure to blockchain technology maintains the legal certainty of warehouse receipts while adding the benefits of digital transfer and tracking. A tokenized warehouse receipt directly represents a specific quantity of verified gold resources through a standardized format compliant with state warehouse receipt requirements, establishing clear chain of title and ownership rights while integrating with existing commodity trading frameworks. According to embodiments, this structure effectively separates the receipt from corporate entity ownership while maintaining compliance with state-level commodity warehouse regulations.

According to embodiments, this warehouse receipt framework provides the foundation for subsequent blockchain implementation and distributed ledger systems, ensuring that the technical architecture serves and enhances established legal structures rather than attempting to replace them. According to embodiments, the asset management system provides for the integration of traditional warehouse receipt concepts with modern blockchain technology to create a methodology for representing and trading unmined gold deposit rights while maintaining regulatory compliance and market accessibility.

According to embodiments, the asset management system implements real-time operational monitoring through integration with token mining operations software via secure application programming interface (API) connections. This monitoring system incorporates the Real-Time AISC Index to provide continuously updated information on production costs, enabling more accurate valuations and operational decisions. By subtracting the AISC Index from current gold prices, the system calculates real-time profit margins, which serve as a baseline for determining in-ground economic value of unmined deposits.

The Real-Time AISC Index serves as a fundamental component of the token pricing mechanism through a dynamic pricing algorithm that continuously recalibrates token values based on the spread between current gold spot prices and the index. This approach ensures that token prices reflect not only the underlying resource estimates but also the evolving economic extractability of those resources. When the spread widens, indicating increased profitability in gold production, the algorithm proportionally adjusts the valuation multipliers applied to measured, indicated, and inferred resources. The pricing engine incorporates these adjustments through oracle feeds that update at fifteen-minute intervals, ensuring token values maintain alignment with current market conditions.

According to embodiments, the asset management system can be employed to process ESG credits and compliance via an integration with one or more ESG crediting systems with the smart contract infrastructure to track metrics (e.g., issue metrics) against permitted thresholds. According to embodiments, the asset management system implements ESG crediting systems that are integrated with the smart contract infrastructure, tracking issue metrics against permitted thresholds. According to embodiments, the asset management system performs AISC-ESG Correlation Analysis that provides quantitative insights into how ESG practices correlate with optimized production costs over time, creating a financial incentive mechanism that reinforces responsible mining practices. The asset management system maintains a continuously updated database of these correlations, enabling it to identify and reward tokenized deposits that demonstrate cost advantages attributable to sustainable operational practices.

According to embodiments, the asset management system performs operations relating to token burning. According to embodiments, as real world deposits are transformed from unmined to active mining, the asset management system manages the reduction of tokens associated with those real-world assets through a token burning protocol. According to embodiments, the asset management system incorporates production cost data from the Real-Time AISC Index to enable accurate valuation during the transition from unmined to actively mined deposits. Real-world mining data from operational owners is cross-referenced with assay results and independently verified by appointed auditors. This data then engages committed smart contracts requiring multi-signature validation and confirmation from operational, technical, and compliance stakeholders before executing token burns. According to embodiments, real world/real time mining data from operational owners is cross-referenced with assay results and independently verified by appointed auditors. In an embodiment, the data engages the committed smart contracts and may require multi-signature validation and confirmation from operational, technical, and compliance stakeholders before executing token burns. In an embodiment, the token burn may including one or more of the following operations: a) Mining data is collected and hashed on-chain, b) a qualified person validates extraction data, c) an independent auditor verify compliance, d) smart contracts include checks for required signatures, and (e) token burn amount is calculated based on verified extraction and current AISC metrics. According to embodiments, the safety protocols for token burns may also include: a) rate limiting to prevent excessive burns, b) emergency pause functionality, c) minimum time-locks between burns, d) maximum burn amounts per session, and e) multi-signature approval for large burns. In an embodiment, the token burn protocol includes a recovery mechanism in case of operational errors or legal proceedings requirements.

According to embodiments, the asset management system incorporates the Real-Time AISC Index representing the gold mining industry's first s real-time index of All-In Sustaining Costs. Unlike traditional AISC calculations that are updated quarterly by the World Gold Council, the index employed by the asset management system provides a real time weighted global average by incorporating the latest production and cost figures as they are reported by individual companies. In an embodiment, by subtracting this index from the market price of above-ground gold, the system calculates the global average profit margin per ounce, establishing an intrinsic value benchmark for in-ground gold deposits. Advantageously, the asset management system enables accurate and timely valuations of unmined gold deposits represented by tokens within the system.

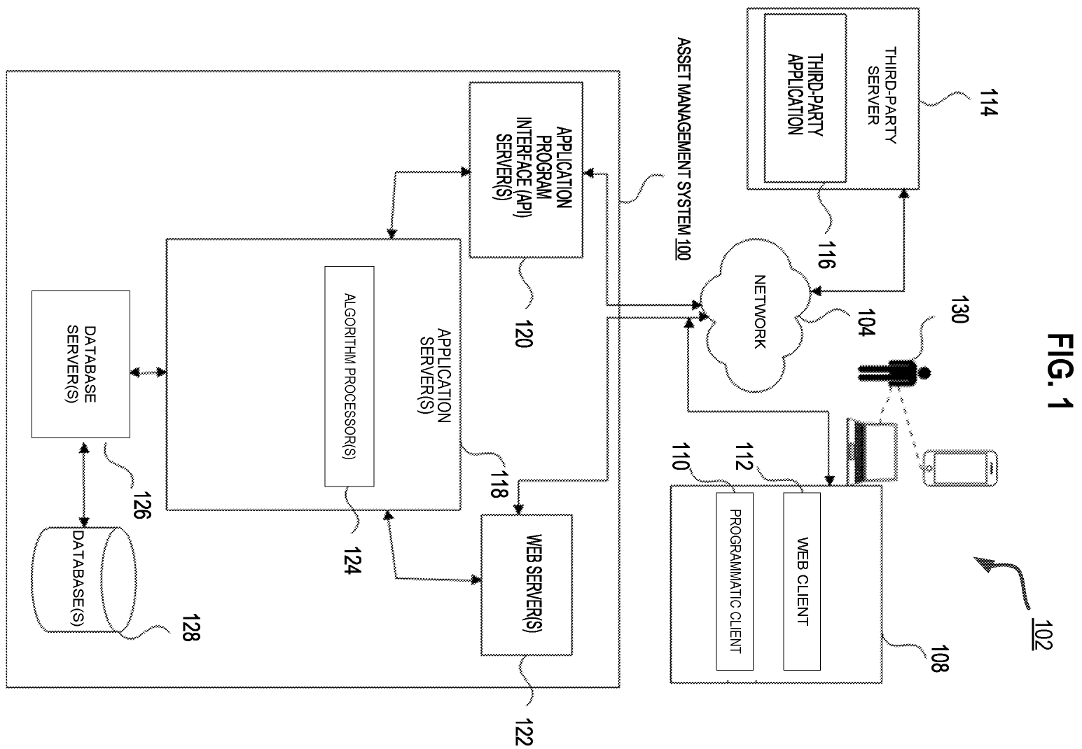

FIG. 1 is a diagrammatic representation of a networked computing environment 102 including an asset management system 100, in accordance with embodiments of the present disclosure. According to embodiments, the asset management system 100 may include one or more computing devices (e.g., application servers such as application server 118) configured to server-side functionality via a network 104 to a networked user device, in the form of a client device 108 that is accessed by a user 130. In an embodiment, a web client 112 (e.g., a browser) and a programmatic client 110 (e.g., an application or “app”) are hosted and executed on the web client 112.

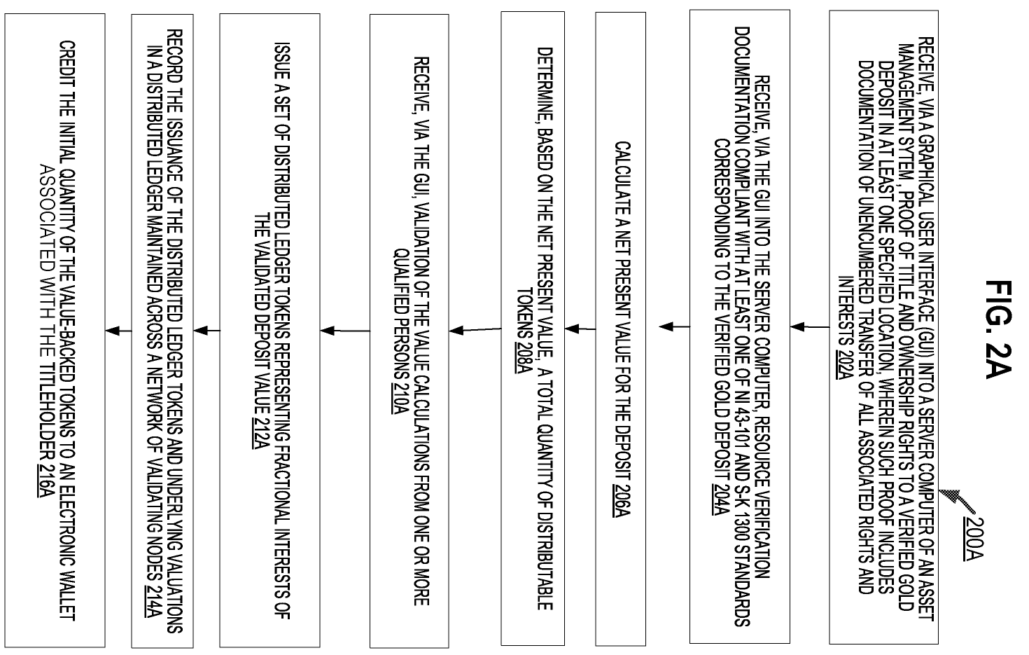

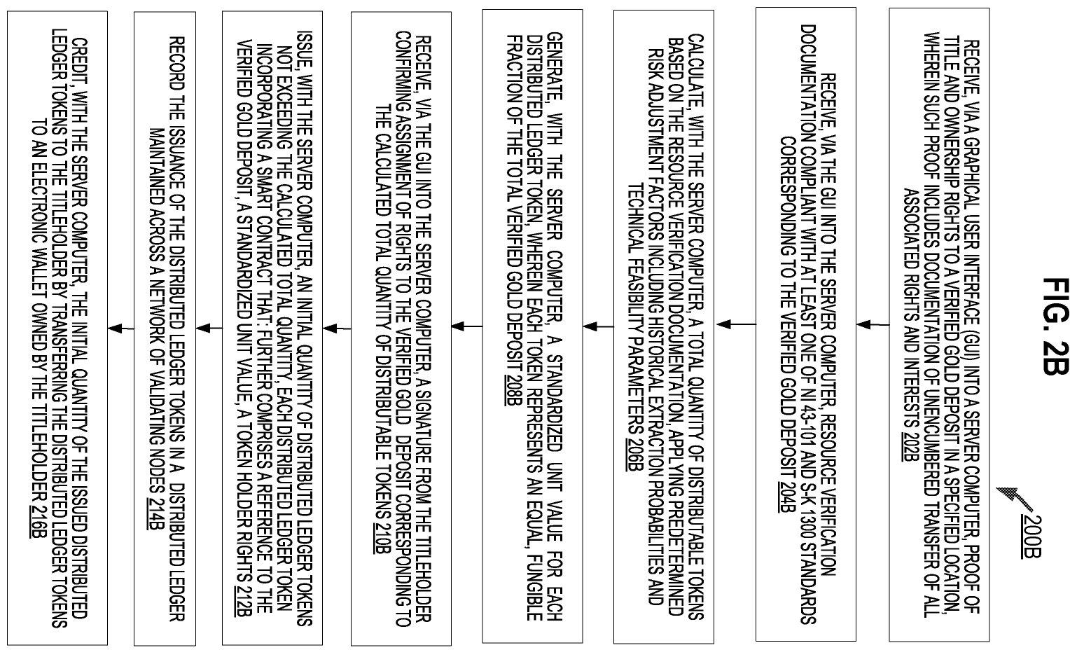

According to embodiments, an application program interface (API) server 120 and a web server 122 provide respective programmatic and web interfaces to the asset management system 100. In an embodiment, the asset management system 100 includes an application server 118 configured to host one or more processing devices (e.g., algorithm processor 124) which includes components, modules and/or applications configured to perform operations, functions, and steps as described in detail with reference to FIGS. 2A-11.

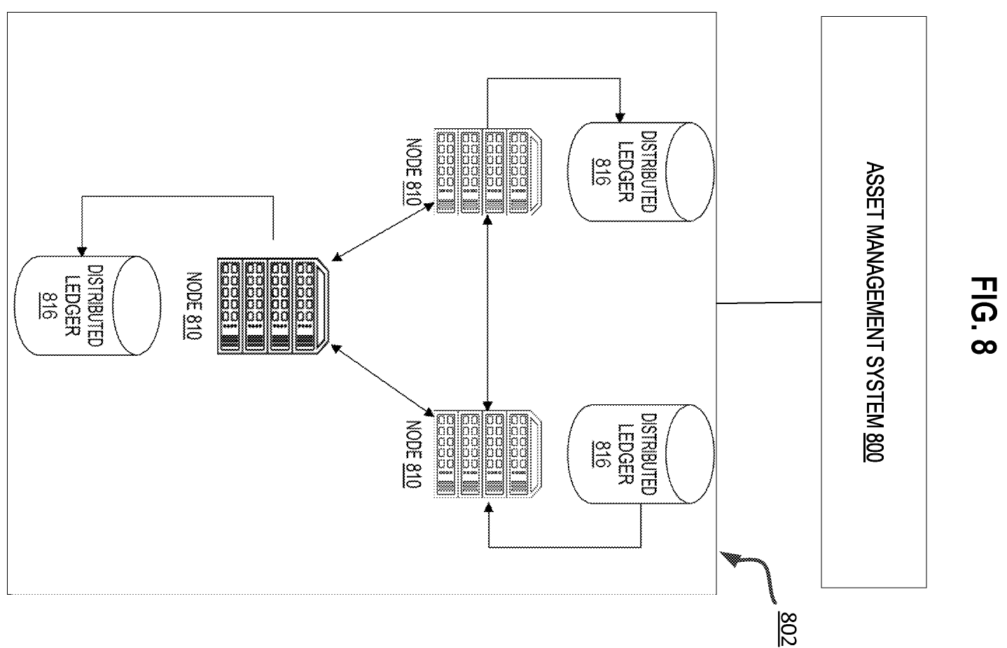

According to embodiments, the web client 112 communicates with the asset management system 100 (e.g., algorithm processor 124 of the asset management system 100) via the web interface supported by the web server 120. In an embodiment, the programmatic client 110 communicates with the asset management system 100 (e.g., algorithm processor 124 of the asset management system 100) via a programmatic interface provided by an API application on the API server 120. The third-party application 816 may, for example, be a distributed ledger (e.g., distributed ledger 816 of FIG. 8) or a node (e.g., node 810 of FIG. 8) of a third party system configured to register tokens related to unmined gold deposits.

According to embodiments, the one or more application servers 118 of the asset management system 100 are communicatively coupled to one or more database servers 126 that facilitate access to an information storage repository or one or more databases 128. In an example embodiment, the databases 128 may include storage devices that store information to be published and/or processed by the one or more algorithm processors 124 of the asset management system 100.

In an embodiment, a third-party application 116 executing on a third-party server 114, is shown as having programmatic access to the one or more applications servers 118 of the asset management system 100 via the programmatic interface provided by the one or more API server 120. In an embodiment, the third-party application 116 executing on a third-party server 114, is shown as having programmatic access to a user interface (e.g., an environmental considerations user interface) corresponding to an API server 120 of the asset management system 100. According to embodiments, the third-party application 116, using information retrieved from the application server 118, may support one or more features or functions on a website hosted by the third party.

According to embodiments, the asset management system 100 may include one or more modules configured to perform the operations and functions of the methods and processes described in detail below with reference to FIGS. 2A-11. According to embodiments, the asset management system 100 may include a specialized computing architecture that transforms physical asset documentation into standardized digital representations through a series of technically integrated processes. In an embodiments, the asset management system 100 includes one or more computing devices (e.g., servers) having one or more processors (e.g., algorithm processors 124 of FIG. 1) configured to execute machine-readable instructions stored in non-transitory computer memory, wherein the instructions cause the processors to perform specific technological operations that solve technical problems in digital asset representation and verification.

According to embodiments, the asset management system 100 incorporates a document processing subsystem that receives and validates proof of title documentation through automated parsing algorithms. The asset management system 100 may employ optical character recognition (OCR) technology combined with natural language processing models to extract and verify ownership information from scanned documents. According to embodiments, the asset management system 100 may execute one or more machine learning models including machine learning classifiers trained to identify specific document types and validate completeness of ownership transfer documentation, reducing manual verification overhead and improving accuracy of title validation processes.

According to embodiments, the asset management system 100 may include a resource verification module configured to process technical documentation compliant with regulatory standards (e.g., NI 43-101 and S-K 1300). In an embodiment, the resource verification module may implement one or more pattern recognition algorithms to identify qualified person signatures, extract resource estimate data, and validate geological survey information. According to embodiments, the asset management system 100 (e.g., the resource verification module) may implement one or more machine learning models trained on historical resource documentation to identify and flag inconsistencies or missing elements in submitted verification materials, enhancing the reliability of resource validation processes.

According to embodiments, the asset management system 100 may include a computational engine that calculates distributable token quantities based on processed resource data. According to embodiments, the computational engine may employ one or more statistical models and risk assessment algorithms that analyze historical extraction probabilities, geological factors, and technical feasibility parameters. In an embodiment, the computational engine of the asset management system 100 may include one or more machine learning regression models trained on mining industry data to predict extraction success rates and adjust token quantities accordingly, providing more accurate representations of underlying asset values.

According to embodiments, the asset management system 100 may include a smart contract generation module configured to create standardized digital tokens with embedded contractual terms. According to embodiments, the smart contract generation module may utilize template-based code generation combined with parameter substitution algorithms to produce blockchain-compatible smart contracts. According to embodiments, the smart contract generation module of the asset management system 100 may employ automated testing frameworks to validate smart contract functionality before deployment, ensuring proper execution of token transfer and rights management operations.

According to embodiments, the asset management system 100 may incorporate a distributed ledger interface that records token issuance across multiple validating nodes. In an embodiment, the distributed ledger interface may implement one or more consensus protocol handlers that manage communication with blockchain networks, ensuring proper transaction validation and immutable record keeping. In an embodiment, the asset management system 100 employ cryptographic hashing algorithms to generate unique token identifiers and maintain data integrity throughout the tokenization process.

According to embodiments, the asset management system 100 may include a wallet management module configured to facilitate electronic wallet operations for token distribution. In an embodiment, the wallet management component may implement multi-signature protocols and secure key management systems to protect token transfers. In an embodiment, the asset management system 100 may employ one or more machine learning anomaly detection models to monitor wallet transactions to identify potentially fraudulent activities, enhancing security of the tokenization platform.

According to embodiments, the asset management system 100 may include a user interface subsystem that provides graphical interfaces for document submission and process monitoring. The user interface subsystem may employ responsive web design frameworks and real-time status update mechanisms to enhance user experience during tokenization operations. In an embodiment, the asset management system 100 may employ one or more machine learning personalization algorithms to adapt interface presentations based on user behavior patterns and preferences.

According to embodiments, the asset management system 100 may include a quality assurance module configured to execute one or more automated validation routines that verify data consistency across processing stages. According to embodiments, the asset management system 100 may include one or more machine learning classification models trained to identify potential errors or inconsistencies in processed documentation, triggering manual review processes when necessary. In an embodiment, the asset management system 100 may implement automated rollback mechanisms to reverse incomplete or erroneous tokenization operations, maintaining data integrity throughout the process.

According to embodiments, the asset management system 100 addresses technical challenges in digital asset creation by providing automated, scalable, and verifiable processes for converting physical asset documentation into blockchain-compatible digital representations. The asset management system 100 integration of machine learning models, cryptographic protocols, and distributed ledger technologies creates a technological solution that improves efficiency, accuracy, and security compared to manual tokenization approaches.

According to embodiments, the asset management system 100 may employ a blockchain including a distributed ledger based on a distributed computing infrastructure that provides immutable record-keeping and cryptographic validation of token transactions through a network of validating nodes, solving the technical problem of establishing verifiable ownership and transferring records for digital asset representations without relying on centralized authorities. According to embodiments, the blockchain implementation employs smart contracts as executable code stored on the distributed ledger that automatically enforce token transfer rules and ownership rights, creating a technological solution that eliminates manual contract enforcement and reduces computational overhead in managing complex multi-party asset transactions.

According to embodiments, the asset management system 100 employs smart contracts for automated compliance and transfer restrictions. According to embodiments, the asset management system 100 provides for integration of regulatory standards (e.g., NI 43-101/S-K 1300) and ESG tracking functionality. In an embodiment, the asset management system 100 employs token burning protocols tied to real-world mining activity and multi-signature validation and deep web transaction mechanisms for security.

According to embodiments, the asset management system 100 provides a secure, legally compliant, and environmentally conscious platform for representing and trading unmined gold deposits in the digital realm. Advantageously, the asset management system addresses and overcomes issues in the digitization and trading of unmined gold deposits by incorporating rigorous verification standards (NI 43-101 and S-K 1300), enabling proper authentication of the resource estimates by qualified persons. According to embodiments, the asset management system 100 integrates the industry's first real-time All-In Sustaining Cost (AISC) index for accurate economic valuation.

According to embodiments, the asset management system 100 provides a framework for managing access rights to mining deposits while providing continuous economic viability assessment through a Real-Time AISC Index. The cost metric index (e.g., the AISC index) provides a continuously updated weighted global average of gold production costs, creating an unprecedented level of valuation accuracy for unmined deposits. According to embodiments, the asset management system 100 calculates real-time profit margins by subtracting the AISC Index from current gold prices, which serve as a baseline for determining in-ground economic value of unmined deposits.

According to embodiments, the asset management system 100 addresses environmental concerns through direct integration of ESG tracking within the smart contract infrastructure, helping ensure mining operations credits aligned with environmental standards. According to embodiments, the asset management system 100 correlates ESG performance with AISC metrics, thereby incentivizing sustainable practices that reduce production costs. According to embodiments, the asset management system 100 performs AISC-ESG correlation analysis that provides quantitative insights into how superior ESG practices correlate with optimized production costs over time, creating a financial incentive mechanism that reinforces responsible mining practices.

According to embodiments, the asset management system 100 resolves security concerns inherent in digital asset trading through innovative transaction mechanisms and multi-signature validation protocols, protecting participants during token exchanges. In an embodiment, the asset management system implements the token architecture through a series of smart contracts deployed on an enterprise-grade blockchain platform, encoding the relationship between physical claims and digital tokens and incorporating resource documentation through smart contracts that reference authenticated NI 43-101 or S-K 1300 technical reports and current AISC index values.

According to embodiments, the asset management system 100 enables valuation adjustments in real time when the AISC index reflects significant changes in global production costs, with smart contracts automatically recalibrating token values to maintain economic accuracy. According to embodiments, the asset management system 100 generates a deposit risk profile that quantifies the economic resilience of each tokenized resource by analyzing the specific deposit's projected production costs against the global AISC index, with this risk assessment updated continuously as the AISC index fluctuates, providing token holders with real-time visibility into how changing production economics affect their specific holdings.

FIG. 2A is a flow diagram of an example method 200A executable by an asset management system (e.g., asset management system 100 of FIG. 1) to generate a valuation for one or more assets, such as a verified unmined gold deposits, according to embodiments of the present disclosure. According to embodiments, the method 200A includes steps and operations to determine and tokenize a value of verified unmined gold deposits (also referred to as “valuation method 200A”). The method 200A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In step 202A, the valuation method 200A receives, via a graphical user interface (GUI) into a processing device (e.g., one or more processing devices of a server computer of an asset management system), proof of title and ownership rights to a verified gold deposit in a specified location. According to embodiments, the proof of title and ownership rights includes documentation of unencumbered transfer of all associated rights and interests. In step 204A, the tokenization method 200 receives, via the GUI, resource verification documentation compliant with one or more standards (e.g., at least one of NI 43-101 and S-K 1300 standards) corresponding to the verified gold deposit. In an embodiment, the resource verification documentation includes one or more of drill data, assay results, or geological models.

In step 206A, the valuation method 200 calculates (e.g., with a processing device of a server computer of the asset management system) a net present value for the deposit. In an embodiment, the net present value is calculated by applying one or more resource classification multipliers for the resources based on a resource type. For example, a first resource classification multiplier (e.g., 0.8) may be applied for measured resources (e.g., a first resource type), a second resource classification multiplier (e.g., 0.4) may be applied for indicated resources (e.g., a second resource type), and a third resource classification multiplier (e.g., 0.2) may be applied for inferred resources (e.g., a third resource type).

In an embodiment, calculating the net present value may include the incorporation or consideration of one or more technical modifying factors (e.g., recovery rates, dilution, processing costs, etc.). In an embodiment, calculating the net present value may include projecting operating costs and/or capital expenditures over the corresponding mine life associated with the asset. In an embodiment, calculating the net present value may include forecasting revenue streams using commodity price projections. In an embodiment, calculating the net present value may include applying jurisdiction-specific discount rates reflecting permitting and development timelines.

In step 208A, the valuation method 200A determines, based on the net present value, a total quantity of distributable tokens. According to embodiments, the total quantity of distributable tokens is determined by dividing the calculated net present value by a standardized unit value. In an embodiment, the standardized unit value is derived from market comparable transactions for similar deposits.

In step 210A, the valuation method 200A receives validation of the value calculations from one or more qualified persons (e.g., qualified persons as defined under an applicable standard such as the NI 43-101 standard and/or the S-K 1300 standard).

In step 212A, the valuation method 200A issues a set of distributed ledger tokens representing fractional interests of the validated deposit value. In an embodiment, each distributed ledger token incorporates a smart contract. In an embodiment, each smart contract includes one or more references to the underlying resource calculations, one or more references to one or more technical assumptions. In an embodiment, each smart contract establishes mechanisms for value updates based on new technical data or market conditions. In an embodiment, each smart contract defines token holder rights regarding value realization.

In step 214A, the valuation method 200A records the token issuance and underlying valuations in a distributed ledger maintained across a network or set of validating nodes. In step 216A, the valuation method 200A credits the initial quantity of the value-backed tokens to an electronic wallet associated with (e.g., owned by) the titleholder. In an embodiment, the initial quantity of the issued distributed ledger tokens are credited to the titleholder by transferring the distributed ledger tokens to an electronic wallet owned by the titleholder.

According to embodiments, FIG. 2A illustrates a valuation method 200A relating to the valuation, tokenization, and issuance of underlying valuations of a single gold deposit. According to embodiments, the valuation method 200A may be executed to generate a valuation and tokenize any number of gold deposits. According to embodiments, the tokenization method 200A may be executed to establish a fungible token that represents a fractional value related to a plurality of total unmined gold deposits across a plurality of locations.

FIG. 2B is a flow diagram of an example method 200B executable by an asset management system (e.g., asset management system 100 of FIG. 1) to tokenize verified unmined gold deposits, according to embodiments of the present disclosure. The method 200B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In step 210, the tokenization method 200B receives, via a graphical user interface (GUI) into a server computer, proof of title and ownership rights to a verified gold deposit in a specified location, wherein such proof includes documentation of unencumbered transfer of all associated rights and interests. In step 204B, the tokenization method 200B receives, via the GUI into the server computer, resource verification documentation compliant with one or more standards (e.g., at least one of NI 43-101 and S-K 1300 standards) corresponding to the verified gold deposit. In an embodiment, the resource verification documentation includes one or more of drill data, assay results, or geological models.

In step 206B, the tokenization method 200B calculates (e.g., with a processing device of a server computer) a total quantity of distributable tokens based on the resource verification documentation, applying predetermined risk adjustment factors including historical extraction probabilities and technical feasibility parameters.

In step 208B, the tokenization method 200B generates (e.g., with a processing device of a server computer) a standardized unit value for each distributed ledger token, wherein each token represents an equal, fungible fraction of the total verified gold deposit. In step 210B, the tokenization method 200B receives, via the GUI into the server computer, a signature from the titleholder confirming assignment of rights to the verified gold deposit corresponding to the calculated total quantity of distributable tokens. In step 212B, the tokenization method 200B issues, with the server computer, an initial quantity of distributed ledger tokens not exceeding the calculated total quantity, each distributed ledger token incorporating a smart contract that: further comprises a reference to the verified gold deposit, a standardized unit value, a token holder rights.

In step 214B, the tokenization method 200B records the issuance of the distributed ledger tokens in a distributed ledger maintained across a network of validating nodes. In step 216B, the tokenization method 200B credits, with the server computer, the initial quantity of the issued distributed ledger tokens to the titleholder by transferring the distributed ledger tokens to an electronic wallet owned by the titleholder.

According to embodiments, FIG. 2B illustrates a tokenization method 200B relating to the tokenization of a single gold deposit. According to embodiments, the tokenization method 200B may be executed to tokenize any number of gold deposits. According to embodiments, the tokenization method 200B may be executed to establish a fungible token that represents a fractional value related to a plurality of total unmined gold deposits across a plurality of locations.

According to embodiments, the asset management system 100 performs the tokenization method 200B using a cost index (e.g., the real-time AISC index) as an input for the comprehensive risk assessment framework applied to each tokenized deposit. In an embodiment, the asset management system 100 analyzes each specific deposit's projected production costs against the global AISC index, and generates a deposit risk profile that quantifies an economic resilience or strength of the resource. In an embodiment, deposits with projected costs significantly below the current AISC index receive favorable risk ratings, while those with costs approaching or exceeding the index trigger supplementary risk disclosures to potential token holders. This risk assessment is updated continuously by the asset management system 100 as the AISC index fluctuates, providing token holders with real-time visibility into how changing production economics affect their specific holdings.

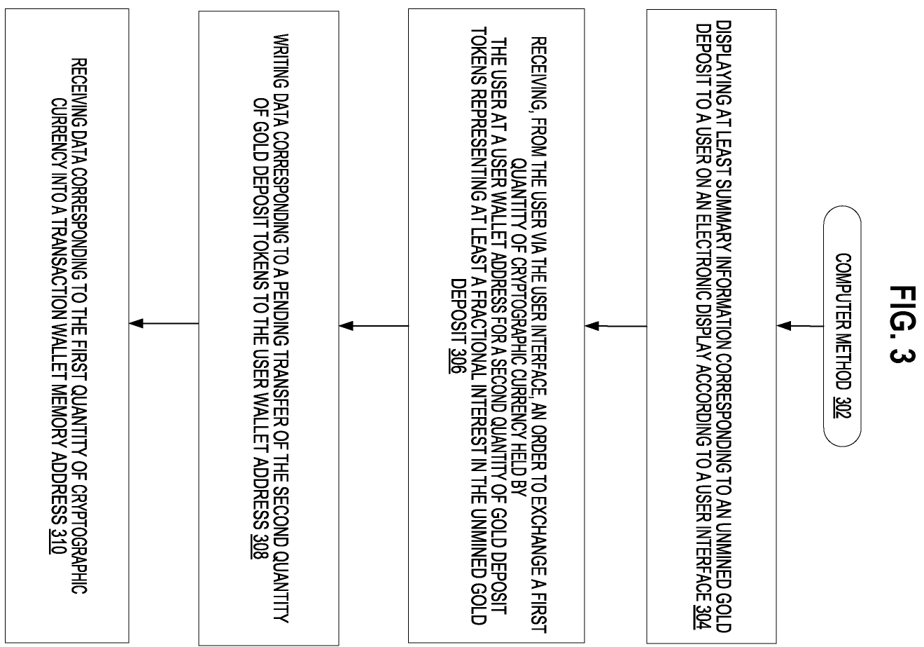

FIG. 3 is a flow chart showing a method 302 executable by an asset management system (e.g., asset management system 100 of FIG. 1) for secure transfer of a blockchain token representing an interest in an unmined gold deposit, according to embodiments of the present disclosure.

In step 304, a processing device (e.g., a processing device of the asset management system 100 of FIG. 1) displays at least summary information corresponding to an unmined gold deposit to a user on an electronic display according to a user interface. According to embodiments, the summary information corresponding to the unmined gold deposit, as used here and as referenced throughout this disclosure, may include one or more of an identifier, a description, a country where the deposit is located, current and/or prior owner information, identification of geological surveys conducted, one or more resource estimates compliant with one or more standards (e.g., NI 43-101 or S-K 1300 standards), one or more dates related to claim validity and/or expiration, geological surveys related to the gold deposit, and/or an identifier of related gold deposits. According to embodiments, the summary information includes tokenization information such as current token holder(s), types and/or terms of ownership, and/or availability of tokens. According to embodiments, the summary information may identify a type of the gold deposit, e.g., placer, lode, proven reserves, probable reserves, or the like, a pending resource verification, and/or geological assessment. According to embodiments, the summary information may identify a chain of title in the gold deposit.

According to embodiments, in step 306, the processing device receives, from the user via the user interface, an order to exchange a first quantity of cryptographic currency held by the user at a user wallet address for a second quantity of gold deposit tokens representing at least a fractional interest in the unmined gold deposit. According to embodiments, the term "user wallet address" may include a data string, such as an alphanumeric code, that is generated to receive transactions and transmit transactions. In an embodiment, the user wallet address may be generated from a public key. The public key is derivable from a private key known to a party having ownership of the wallet (or alternatively, from a private key that is held in custody of the wallet), but the private key cannot be derived from the public key, owing to use of a hyperbolic function that is a "one-way" function. The contents (and authority for transferring the contents) of a wallet address are accessible by the party holding the private key.

According to embodiments, at step 308, the processing device writes data corresponding to a pending transfer of the second quantity of gold deposit tokens to the user wallet address. According to embodiments, in step 310, the processing device receives data corresponding to the first quantity of cryptographic currency into a transaction wallet memory address.

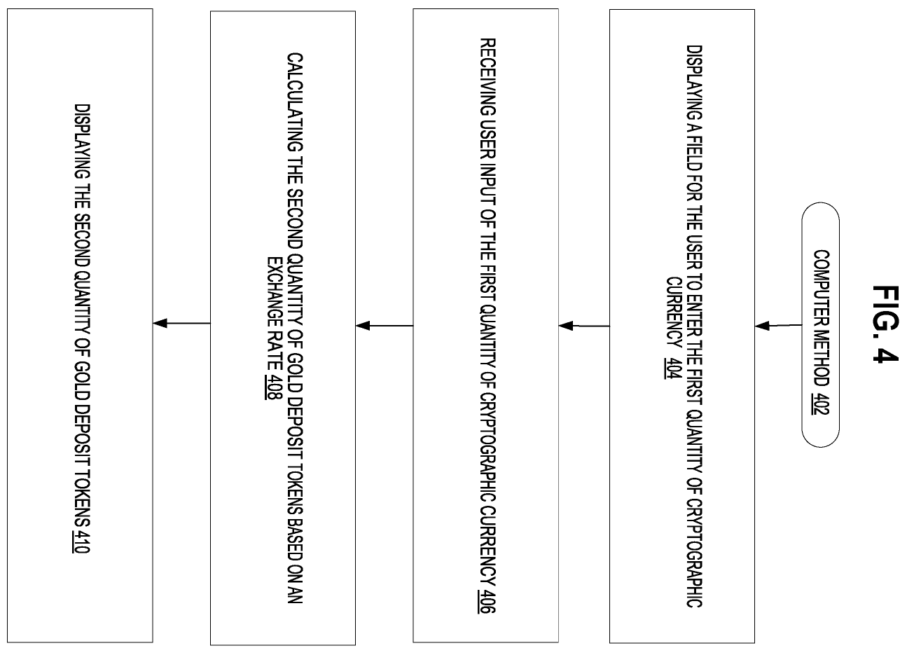

FIG. 4 is a flow chart illustrating a method 402 executable by an asset management system (e.g., asset management system 100 of FIG. 1) for displaying a quantity of blockchain tokens representing an unmined gold deposit corresponding to a selected amount of a cryptographic currency as a function of an exchange rate, according to one or more embodiments.

In step 404, a processing device (e.g., a processing device of the asset management system 100 of FIG. 1) displays a field for the user to enter the first quantity of cryptographic currency. In step 406, the processing device receives user input of the first quantity of cryptographic currency. In step 408, the processing device calculates the second quantity of gold deposit tokens based on an exchange rate. In an embodiment, in step 408, the processing device further calculates the exchange rate based on relative supply and demand of the cryptographic currency and the gold deposit tokens. In an embodiment, the processing device calculates the exchange rate based on a supply and demand of the cryptographic currency and a specified price of the gold deposit tokens. In step 410, the processing device displays the second quantity of gold deposit tokens.

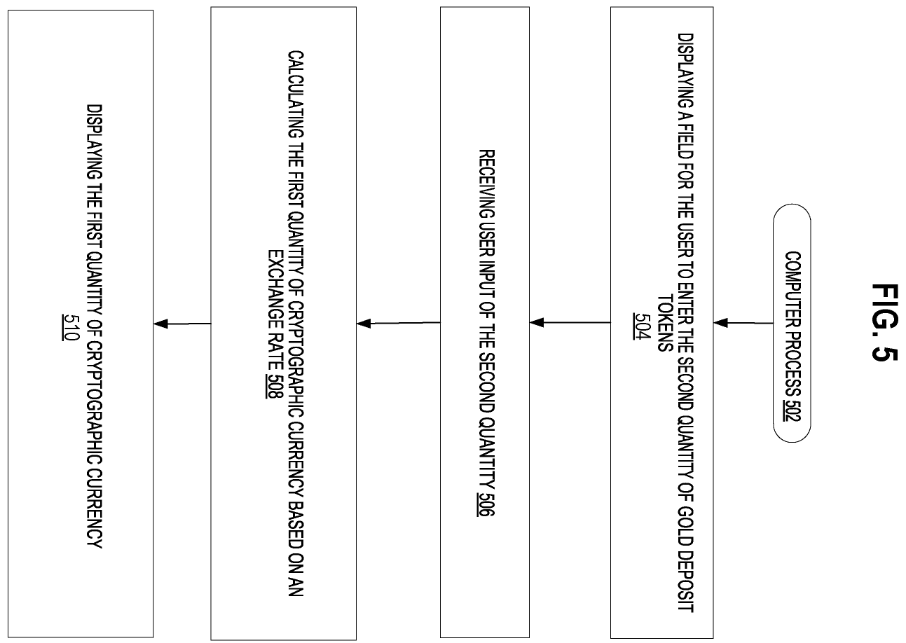

FIG. 5 is a flow chart illustrating a method 502 executable by an asset management system (e.g., asset management system 100 of FIG. 1) for displaying a quantity of a cryptographic currency corresponding to a selected amount of blockchain tokens representing an unmined gold deposit as a function of an exchange rate, according to one or more embodiments. According to embodiments, the method 502 may be performed as part of the displaying of at least summary information about the unmined gold deposit from step 304 of FIG. 3.

In step 504, a processing device (e.g., a processing device of the asset management system 100 of FIG. 1) displays a field for the user to enter the second quantity of gold deposit tokens. In step 506, the processing device receives user input of the second quantity. In step 508, the processing device calculates the first quantity of cryptographic currency based on an exchange rate. In step 510, the processing device displays the first quantity of cryptographic currency.

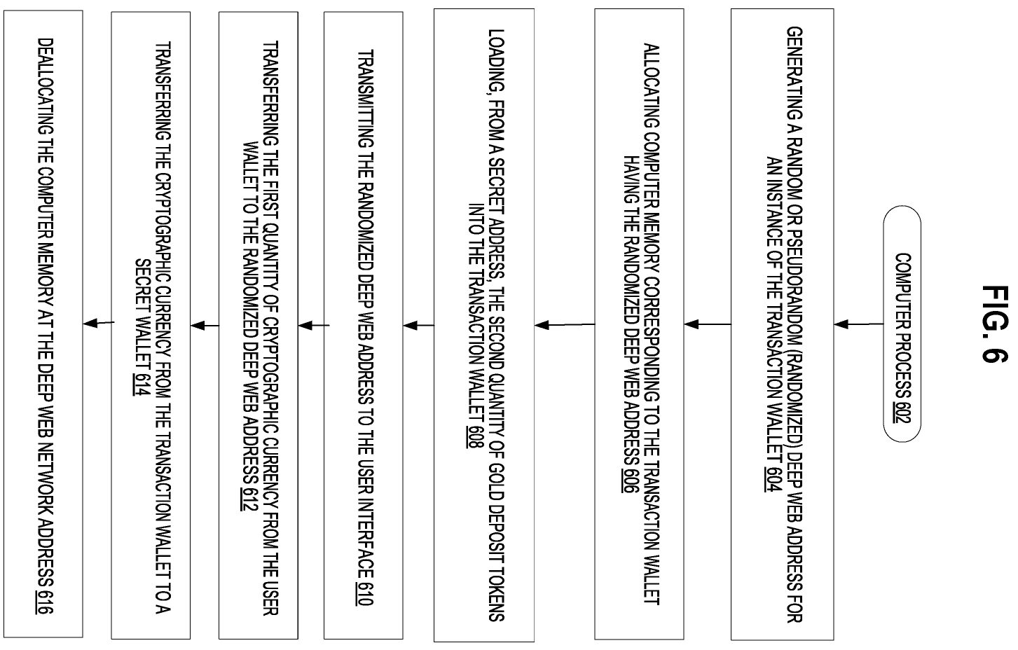

FIG. 6 is a flow chart illustrating a method 602 executable by an asset management system (e.g., asset management system 100 of FIG. 1) for exchanging a cryptographic currency for blockchain tokens representing an unmined gold deposit, according to one or more embodiments. According to embodiments, method 602 may be performed as part of the display of at least summary information about the unmined gold deposit from step 304 of FIG. 3, where step 304 includes displaying a field for the user to enter a committed bid price of the gold deposit tokens. According to embodiment, method 602 may be performed as part of the receiving of the order to exchange the first quantity of cryptographic currency for the second quantity of gold deposit tokens from step 306 of FIG. 3, wherein step 306 further includes receiving the committed bid price. In an embodiment, the smart contract may include the commitment to sell at least a portion of the gold deposit tokens at the committed bid price. In an embodiment, additionally, or alternatively, displaying at least summary information about an unmined gold deposit from step 304 of FIG. 3 may include displaying a committed selling price. In an embodiment, the smart contract includes the commitment to sell at least a portion of the gold deposit tokens at the committed selling price.

With reference to FIG. 6, in step 604, the processing device generates a random or pseudorandom (e.g., randomized) deep web address for an instance of a transaction wallet. For example, step 604 may include generating a new public key not previously associated with a blockchain transaction or generating a new private key and deriving a new public key from the new private key not previously associated with a blockchain transaction.

In step 606, the processing device allocates computer memory corresponding to the transaction wallet having the randomized deep web address (e.g., a deep web network address). In step 608, the processing device loads (e.g., retrieves, receives, collects, etc.), from a secret address, the second quantity of gold deposit tokens into the transaction wallet. In step 610, the processing device transmits the randomized deep web address (e.g., the deep web network address) to the user interface. In an embodiment, a deep web network address includes a first portion that is indexed by and/or linked from a surface web location accessible by conventional web search engines, and a second portion that is unpredictable and sufficiently long to substantially prevent systematic search. In an embodiment, the deep web network address may thus be non-indexed and non-linked. In an embodiment, the deep web network address may be uncrawlable. According to a solution variant, the deep web network address does not require registration or login. In an alternative solution variant, the deep web network address may be a contextual address, such as an address configured to be accessible to query by devices having a predetermined URL access history. The deep web network address may be generated by a JavaScript or other randomizing or pseudo-randomizing application. According to an embodiment, the deep web network address may include a Uniform Resource Identifier (URI) including a URL that is indexed and, associated with the URL, a non-indexed query including a passcode that is generated by a random number or pseudo-random number generator and which provides a path to the proposal.

In step 612, the processing device transfers (e.g., causes an electronic transfer) the first quantity of cryptographic currency from the user wallet to the randomized deep web network address. In step 614, the processing device transfers the cryptographic currency from the transaction wallet to a secret wallet. In step 616, the processing device deallocates the computer memory at the deep web network address.

According to one or more embodiments, the cryptographic currency includes value carried by a public blockchain. Additionally or alternatively, the cryptographic currency includes at least one transaction history verifiable by the public blockchain. In an embodiment, the cryptographic currency includes fungible value. In an embodiment, the cryptographic currency includes at least one transaction history carried by a permissioned blockchain.

According to embodiments, with reference to FIG. 3, the method 302 may include the fulfillment of a smart contract to validate the gold deposit tokens. In an embodiment, in step 306, the at least a fractional interest in the unmined gold deposit may include at least fractional ownership of the unmined gold deposit. Additionally, or alternatively, the at least a fractional interest in the unmined gold deposit may include at least fractional rights to a revenue stream from the unmined gold deposit.

According to embodiments, in step 304, the unmined gold deposit may include a verified resource estimate. Additionally, or alternatively, the unmined gold deposit may include a standards-compliant resource assessment. In an embodiment, the unmined gold deposit may include a pending resource verification. In an embodiment, the unmined gold deposit may include a geological survey. In an embodiment, the unmined gold deposit may include an assay report. In an embodiment, the unmined gold deposit may include geophysical data. In an embodiment, the unmined gold deposit may include drill core data.

According to embodiments, in method 602, the asset management system employs advanced predictive analytics that leverage historical patterns in a generated cost index (e.g., the Real-Time AISC index) to forecast potential shifts in industry economics. According to embodiments, the asset management system 100 employs one or more analytics modules to analyze the rate of change in the AISC index, correlate it with macroeconomic indicators, and identify leading signals that precede significant movements in production costs. According to embodiments, the asset management system generates one or more resulting predictive models enable the asset management system to forecast (e.g., predict) how evolving cost structures affect an economic viability of tokenized deposits over various time horizons. According to embodiments, token holders can access these projections through customizable dashboard interfaces, allowing them to make more informed decisions about acquisition, retention, or liquidation of their token holdings based on forward-looking economic indicators rather than merely current valuations (e.g., static valuations).

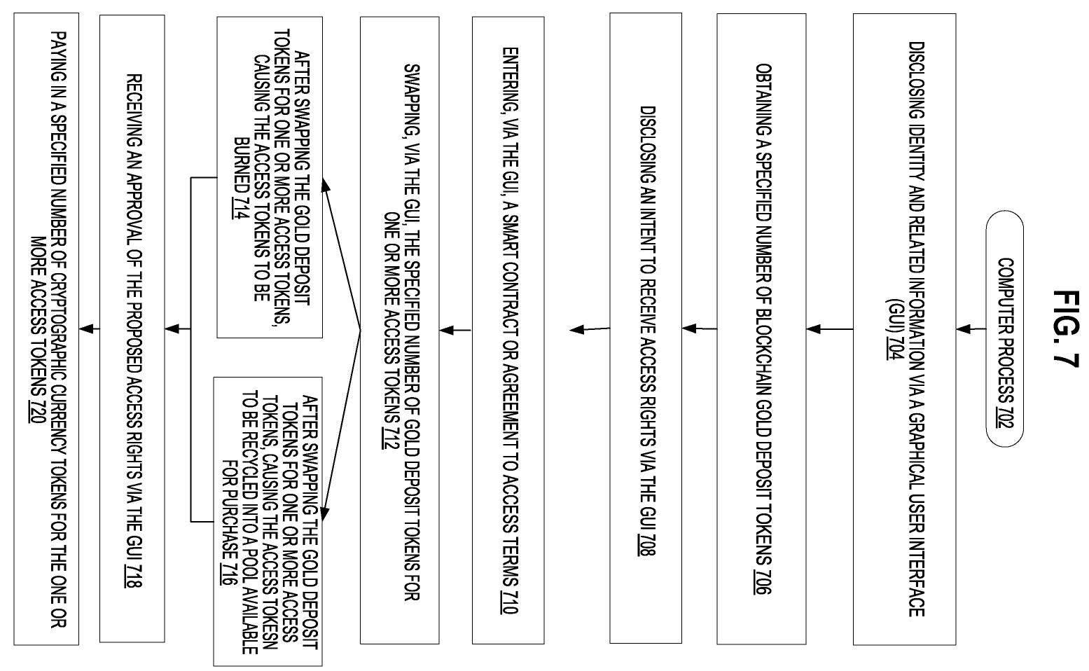

FIG. 7 is a flow chart illustrating a method 702 for receiving or obtaining access rights to an unmined gold deposit. According to embodiments, in step 704, a processing device discloses an identity and related information via a graphical user interface (GUI) on an electronic device (e.g., a user device) networked to a server computer. In an embodiment, step 704 may include establishing a user account with a digital gold exchange, using the GUI.

In step 706, a specified number of blockchain gold deposit tokens are obtained, where each token represents a fractional interest in an unmined gold deposit, by swapping a cryptographic currency value for the gold deposit tokens via the GUI. In an embodiment, the specified number of gold deposit tokens, obtained in step 706, is constant. In an embodiment, the specified number of gold deposit tokens, obtained in step 706, is variable. In an embodiment, the specified number of gold deposit tokens, obtained in step 706, is a function of a number of the gold deposit tokens, corresponding to a particular unmined gold deposit, in circulation.

In an embodiment, the specified number of gold deposit tokens is a function of the identity of the proposed token holder. For example, a lister of a gold deposit may require a larger number of tokens from a known competitor. In an embodiment, the specified number of gold deposit tokens is a function of projected annual value of the gold deposit. In an embodiment, the specified number of gold deposit tokens is a function of a size of the proposed token holder. In a solution variant, the specified number of gold deposit tokens is a function of a territory of the proposed token holder. In an embodiment, the specified number of gold deposit tokens is a function of environmental preservation commitments. In a solution variant, the specified number of gold deposit tokens is a function of a territory allowed under the access rights.

In an embodiment, the specified number of gold deposit tokens is a function of a territory excluded under the access rights. In an embodiment, the specified number of gold deposit tokens is a function of a duration of the access rights. In an embodiment, the specified number of gold deposit tokens is a function of a limitation to exploratory activities. In a solution variant, the specified number of gold deposit tokens is a function of resource estimates covered under the access rights. In an embodiment, the specified number of gold deposit tokens is a function of other considerations to be paid for the access rights or related agreement.

In step 708, an intent to receive access rights is disclosed (e.g., communicated) via the GUI. In an embodiment, the computer process 702 for obtaining access to an unmined gold deposit includes, in step 708, entering information related to intended activities via the GUI. In response to receipt of the information related to the intended activities, a server computer may assemble a list of relevant unmined gold deposits available for access according to the respective description of each. For example, the list may be assembled using, for example, Machine Learning (e.g., one or more machine learning models), Neural Networks, Bayesian logic, Boolean logic or other computing machine processes based on comparing terminology (including synonyms, noun pairs, bigrams, etc.) and relationships between terms in the intended activities description to terminology and relationships between terms in descriptions of a population of available unmined gold deposits. The approach may be similar to performing a search combined with sorting for relevance.

In step 710, a smart contract or agreement to access terms is entered via the GUI. In an embodiment, in step 710, the computer method 702 includes receiving a listing of unmined gold deposits related to the intended activities and recommended for access.

In step 712, via the GUI, the specified number of gold deposit tokens is swapped (e.g., exchanged) for one or more access tokens. In an embodiment, the access token may carry a contract granting a right to engage in activity related to the unmined gold deposit while maintaining environmental preservation. In an embodiment, the computer process 702 includes, in step 712, determining that further refinement in the intended activities description is desirable to reduce extraneous recommended listings. In an embodiment, the computer method 702 includes repeating the steps of entering intended activities information, shown in step 710, and receiving a refined listing of unmined gold deposits recommended for access.

In an embodiment, in step 714, swapping the gold deposit tokens for one or more access tokens causes the access tokens to be burned. In an embodiment, in step 716, swapping the gold deposit tokens for one or more access tokens causes the access tokens to be recycled into a pool available for purchase.

In an embodiment, the method 702 includes, in step 718, receiving an approval of the proposed access rights via the GUI. In an embodiment, obtaining a specified number of gold deposit tokens representing a fractional interest in an unmined gold deposit, in step 706, further includes obtaining a specified number of gold deposit tokens representing fractional interests in a plurality of respective unmined gold deposits. In this way, a digital gold exchange may offer bundled gold deposit packages. In an embodiment, each one of a plurality of obtained gold deposit tokens represents an interest in one unmined gold deposit. In another solution variant, one or more of the obtained gold deposit tokens represent an interest in a plurality of unmined gold deposits.

In an embodiment, swapping the specified number of gold deposit tokens for one or more access tokens, in step 720, further includes paying, in a specified number of cryptographic currency tokens, for the one or more access tokens.

According to embodiments, the gold deposit token may correspond to a verified resource estimate or pending verification. In one or more other embodiments, the gold deposit token may correspond to exploration rights. In one or more other embodiments, the gold deposit token may correspond to a distributorship, a right to resell, and/or to a franchise.

FIG. 8 is a diagram illustrating an example distributed electronic ledger system 802 communicatively coupled to an asset management system 100, 800, according to embodiments. In an embodiment, the distributed electronic ledger system 802 includes a distributed ledger 816 that is stored and maintained in a decentralized manner across a plurality of participating nodes 810, in accordance with one or more embodiments of the present disclosure. In an embodiment, the distributed ledger 816 is implemented as a blockchain architecture, utilizing cryptographic linking between sequential data blocks to ensure data integrity and immutability. In an embodiment, each node 810 represents a special purpose computing device equipped with specialized software, which maintains operative communication with other nodes 810 over a secure, redundant network infrastructure.

According to embodiments, the nodes can be categorized into different operational roles, where one or more nodes are owned, managed, or otherwise operated by a managing entity system that possesses elevated privileges to write to, publish to, or otherwise communicate with the other nodes 810 in the distributed electronic ledger system 802. According to embodiments, each participating node 810 hosts either a complete copy of the distributed ledger 816 for maximum redundancy, or a partial copy based on sharding protocols used scalability.

According to embodiments, when additional data records are proposed for inclusion in the distributed ledger 816, a multi-phase validation process is initiated. One or more nodes 810 (e.g., all participating nodes) execute a validation procedure on the proposed additional data records through a consensus algorithm. According to embodiments, the validation process encompasses verification of data structure, cryptographic signatures, transaction validity, and compliance with network rules. After successful validation through the consensus mechanism, the proposed data record undergoes commitment, ensuring it is simultaneously added to each copy of the distributed ledger 816 across all participating nodes 810 in a consistent manner.

According to embodiments, the distributed electronic ledger system 802 may implement various types of consensus algorithms to ensure the integrity and authenticity of data within the distributed ledger. According to embodiments, the relationship between data validation and consensus varies by implementation. In an embodiment, validation of data records is integrated into the consensus algorithm itself. In an embodiment, validation operates as an independent computing layer that complements the consensus mechanism.

According to embodiments, the consensus mechanism implements a "proof of work" ("POW") algorithm, where nodes perform computationally intensive calculations to solve complex cryptographic puzzles. For validation of pending data records, nodes must calculate a cryptographic hash using algorithms (e.g., SHA256) that satisfies specific dynamic difficulty conditions established by the system. This process, termed "mining," transforms certain participating nodes into "miners" or "miner nodes." According to embodiments, the distributed electronic ledger system 802 implements adaptive difficulty targeting by requiring the resulting hash value to fall below a dynamically adjusted threshold. In these solution variants, nodes combine multiple elements into their calculations: a "base string" (e.g., including metadata within a block header, comprising Merkle root hashes, previous block hashes, timestamps, and version information) with a "nonce" (i.e., an incrementing numerical value). During hash calculation using the POW algorithm, the nonce is initialized to 0 and systematically incremented by 1 until a node discovers a nonce value producing a hash that satisfies the current difficulty target. Upon finding a valid solution, the successful node immediately broadcasts both the solution and its proof to all other network nodes for independent verification. Following thorough validation of the "winning" solution by other nodes through parallel verification, the pending data record is cryptographically appended to the terminal block in the distributed ledger.

According to embodiments, the distributed electronic ledger system 802 also comprises fork resolution mechanisms for cases where multiple nodes generate valid solutions within a short time window. In an embodiment, nodes implementing the POW algorithm converge on the chain demonstrating the highest cumulative proof of work (i.e., the chain requiring the greatest computational effort) as the canonical version of the distributed ledger. Any nodes maintaining divergent ledger versions execute a reconciliation protocol to synchronize with the consensus-determined canonical chain.

According to embodiments, the distributed electronic ledger system 802 employs a "proof of stake" ("PoS") algorithm, where validation authority is proportionally distributed based on participants' "stake" within the distributed ledger. The stake quantification system is multifaceted, incorporating factors such as cryptocurrency holdings, token ownership, asset shares, reputation points, or a weighted combination thereof within the distributed ledger ecosystem as it applies to the unmined gold tokens. Block creation and validation rights are allocated through a voting mechanism where voting power correlates directly with stake size. The next canonical block is determined through a weighted consensus process that considers both the number of votes and the stake-weight behind each vote. Participants with larger stakes receive proportionally greater voting allocation rights, creating an economic incentive for maintaining ledger integrity while simultaneously protecting against manipulation attempts.

According to embodiments, the distributed electronic ledger system 802 includes a "practical byzantine fault tolerance" ("PBFT") algorithm, where each node maintains and utilizes an internal state machine for validation purposes. In an embodiment, the process begins when a user or node submits a formally structured request to post a pending data record to the distributed ledger. Each participating node executes the PBFT algorithm against both the pending data record and its current internal state representation, performing rigorous validity checks and state transition calculations. Upon completion of local validation, nodes broadcast cryptographically signed votes (affirming or rejecting validity) to all other network participants. In an embodiment, the distributed electronic ledger system 802 achieves consensus through a tallying mechanism that considers both the total number of votes and the network's fault tolerance threshold. Once a qualified supermajority of nodes (typically 2f + 1 in a system tolerating f failures) have voted in favor, the pending data record is officially designated as "valid" and is atomically committed to the distributed ledger across all participating nodes.

According to embodiments, the distributed ledger 816 implements append-only semantics, prohibiting direct modification of existing data records or associated metadata within the distributed ledger structure (e.g., blocks in a blockchain). Alternative solution variants support controlled modification capabilities while maintaining audit trails through an advanced versioning system that preserves the complete history of data record versions and all modifications. This ensures the distributed ledger 816 maintains a complete, immutable history of all transactions since genesis. The system incorporates fault tolerance mechanisms - if any Node 810 becomes unavailable (due to network partitions, hardware failures, security compromises, or other disruptions), the remaining nodes 810 continue to maintain consensus and serve verified copies of the distributed ledger 816. Furthermore, the system implements data integrity protection - if data records within a particular node 810's copy of the distributed ledger 816 are compromised through deletion, unauthorized modification, or other means, the remaining nodes 810 serve as authoritative references for ledger reconstruction. The distributed electronic ledger system 802 supports multiple recovery modes: in some embodiments, compromised nodes 810 are quarantined to prevent propagation of corrupted data. In other embodiments, compromised nodes 810 execute self-healing protocols to reconstruct their local ledger copy using verified data from healthy nodes 810, coordinated through the consensus mechanism.

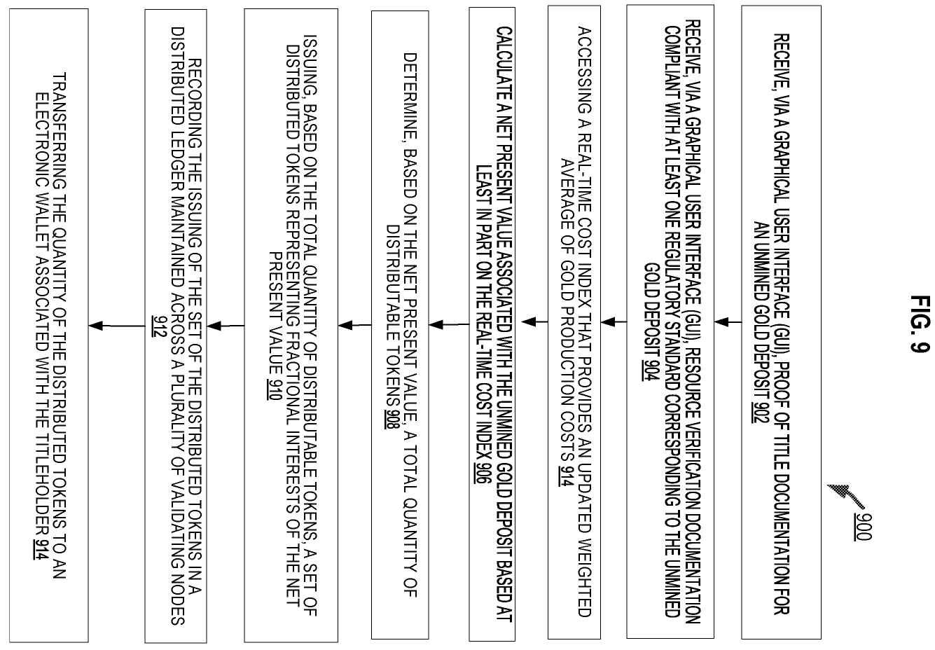

FIG. 9 is a flow diagram of an example method 900 executable by an asset management system (e.g., asset management system 100, 800 of FIGS. 1 and 8, respectively) to tokenize verified assets (e.g., unmined gold deposits), according to embodiments of the present disclosure. The method 900 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In step 902, the processing device receives, via a graphical user interface, proof of title documentation for an unmined gold deposit. In an embodiment, the proof of title documentation includes verification of unencumbered ownership rights. In an embodiment, receiving the proof of title documentation further includes verifying one or more of: a right to conduct geological surveys, a right to perform resource estimates in accordance with applicable standards, a right to maintain valid claim rights, or a right to ensure compliance with environmental preservation requirements of the unmined gold deposit.

In step 904, the processing device receives, via the graphical user interface, resource verification documentation compliant with at least one regulatory standard corresponding to the unmined gold deposit. In an embodiment, the at least one regulatory standard includes one or more of a NI 43-101 standard or S-K 1300 standard. In an embodiment, the resource verification documentation includes drill data, assay results, and geological models.

In step 906, the processing device accesses a real-time cost index that provides an updated weighted average of gold production costs. In an embodiment, the real-time cost index comprises a real-time All-In Sustaining Cost (AISC) index that incorporates quarterly production and cost data as reported by individual mining companies. In an embodiment, the real-time cost index is maintained in a database operatively coupled to the processing device.

In step 908, the processing device calculates a net present value associated with the unmined gold deposit based at least in part on the real-time cost index. In an embodiment, calculating the net present value includes applying resource classification multipliers to measured resources, indicated resources, and inferred resources. In an embodiment, the resource classification multipliers comprise 0.8 for measured resources, 0.4 for indicated resources, and 0.2 for inferred resources. In an embodiment, calculating the net present value further includes incorporating technical modifying factors including recovery rates, dilution, and processing costs. In an embodiment, calculating the net present value further includes projecting operating costs and capital expenditures over the mine life relative to the real-time cost index. In an embodiment, calculating the net present value further includes computing an expected margin between projected gold prices and the real-time cost index over the projected mine life. In an embodiment, calculating the net present value further includes applying jurisdiction-specific discount rates reflecting permitting and development timelines.

In step 910, the processing device determines, based on the net present value, a total quantity of distributable tokens. In an embodiment, determining the total quantity of distributable tokens comprises dividing the calculated net present value by a standardized unit value derived from market comparable transactions for similar deposits. In an embodiment, the standardized unit value is adjusted based on a current spread between gold market prices and the real-time cost index. In an embodiment, the processing device can apply one or more risk adjustment factors. In an embodiment, the one or more risk adjustment factors include one or more of extraction probability data or technical feasibility parameters.

In step 912, the processing device issues, based on the total quantity of distributable tokens, a set of distributed tokens representing fractional interests of the net present value. In an embodiment, each distributed token incorporates a smart contract that comprises a reference to the real-time cost index. In an embodiment, the smart contract establishes mechanisms for value updates based on changes in the real-time cost index. In an embodiment, the smart contract further comprises references to the underlying resource calculations, technical assumptions, and cost index values. In an embodiment, the smart contract defines token holder rights regarding value realization. In an embodiment, the smart contract incorporated in each distributed token includes one or more transfer restrictions based on regulatory compliance requirements and environmental preservation obligations associated with the unmined gold deposit.

In step 914, the processing device records the issuing of the set of distributed tokens in a distributed ledger maintained across a plurality of validating nodes. In an embodiment, recording the token issuance further includes recording underlying valuations and a current cost index benchmark in the distributed ledger. In an embodiment, recording of the issuing of the distributed ledger tokens in the distributed ledger includes broadcasting transaction data corresponding to the distributed ledger tokens to the network of validating nodes, executing a consensus mechanism among the validating nodes to validate the transaction data, where the consensus mechanism comprises at least one of proof-of-work validation, proof-of-stake validation, and practical byzantine fault tolerance protocols; and cryptographically linking the validated transaction data to a previous block in the distributed ledger using hash functions to create an immutable record of token issuance.

In step 916, the processing device transfers the set of distributed tokens to an electronic wallet associated with a titleholder. In an embodiment, the processing device implements a continuous token value adjustment protocol that recalibrates token value based on periodic updates to the real-time cost index, maintaining alignment between token value and current industry economics.

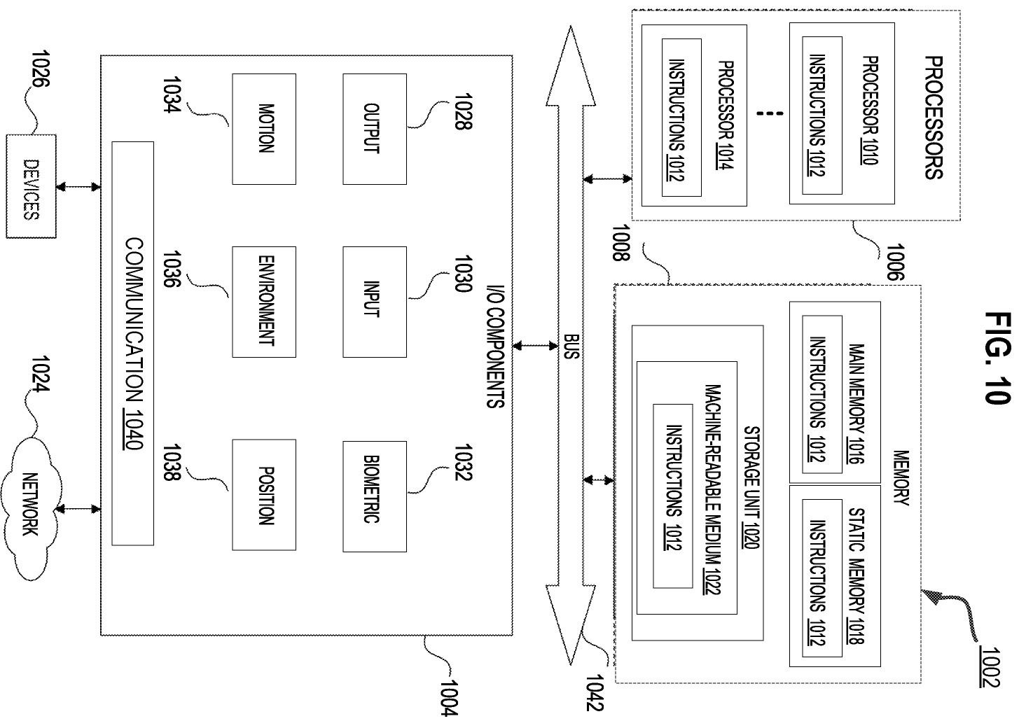

FIG. 10 is a diagrammatic representation of a variant of a machine 1002 implementing embodiments of the present disclosure (described herein with reference to the asset management system 100, 800) within which instructions 1012 (e.g., software, a program, an application, an applet, an app, or other executable code) for causing the machine 1002 and its processors 1006 or processor 1014 to perform any one or more of the methodologies discussed herein may be executed. For example, the instructions 1012 may cause the machine 1002 to execute any one or more of the methods described herein (e.g., methods described with reference to FIGS. 1-8). The instructions 1012 transform the general, non-programmed machine 1002 into a particular machine 1002 programmed to carry out the described and illustrated functions in the manner described. The machine 1002 may operate as a standalone device or may be coupled (e.g., networked) to other machines in a local and/or cloud instance.. In a networked deployment, the machine 1002 may operate in the capacity of a server machine or a client machine in a server-client network environment, or as a peer machine in a peer-to-peer (or distributed) network environment. The machine 1002 may comprise, but not be limited to, a server computer, a client computer, a personal computer (PC), a tablet computer, a laptop computer, a netbook, a PDA, a cellular telephone, a smart phone, a mobile device, a wearable device, other smart devices, a web appliance, a network router, a network switch, a network bridge, or any machine capable of executing the instructions 1012, sequentially or otherwise, that specify actions to be taken by the machine 1002. Further, while only a single machine 1002 is illustrated, the term “machine” shall also be taken to include a collection of machines that individually or jointly execute the instructions 1012 to perform any one or more of the methodologies of this solution as discussed herein.

The machine 1002 may include processors 1006, memory 1008, and I/O components 1004, which may be configured to communicate with each other via a bus 1042. In an example of the solution, the processors 1006 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a processor 1010 and a processor 1014 that execute the instructions 1012. In an embodiment, the term “processor” is intended to include multi-core processors that may comprise two or more independent processors (sometimes referred to as “cores”) that may execute instructions contemporaneously. Although FIG. 10 shows multiple processors 1006, the machine 1002 may include a single processor with a single core, a single processor with multiple cores (e.g., a multi-core processor), multiple processors with a single core, multiple processors with multiples cores, or any combination thereof.

The memory 1008 includes a main memory 1016, a static memory 1018, and a storage unit 1020, both accessible to the processors 1006 via the bus 1042. The main memory 1016, the static memory 1018, and storage unit 1020 store the instructions 1012 embodying any one or more of the methodologies or functions described herein. The instructions 1012 may also reside, completely or partially, within the main memory 1016, within the static memory 1018, within machine-readable medium 1022 within the storage unit 1020 within at least one of the processors 1006 (e.g., within the processor's cache memory), or any suitable combination thereof, during execution thereof by the machine 1002.

The I/O components 1004 may include a wide variety of components to receive input, provide output, produce output, transmit information, exchange information, capture measurements, and so on. The specific I/O components 1004 that are included in a particular machine will depend on the type of machine. For example, portable machines such as mobile phones may include a touch input device or other such input mechanisms, while a headless server machine will likely not include such a touch input device. It will be appreciated that the I/O components 1004 may include many other components that are not shown in FIG. 10. In various example of the solutions, the I/O components 1004 may include output components 1028 and input components 1030. The output components 1028 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1030 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example of the solutions, the I/O components 1004 may include biometric components 1032, motion components 1034, environmental components 1036, or position components 1038, among a wide array of other components. For example, the biometric components 1032 of this solution include components to uniquely key to a particular user to a particular token as identified by the solution and the like.

Communication may be implemented using a wide variety of technologies. The I/O components 1004 further include communication components 1040 operable to couple the machine 1002 to a network 1024 or devices 1026 via respective coupling or connections. For example, the communication components 1040 may include a network interface component or another suitable device to interface with the network 1024. In further examples, the communication components 1040 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1026 may be another machine or any of a wide variety of peripheral devices (e.g., a peripheral device coupled via a USB).

Moreover, the communication components 1040 may detect identifiers or include components operable to detect identifiers. For example, the communication components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and/or memory of the processors 1006) and/or storage unit 1020 may store one or more sets of instructions and data structures (e.g., software) embodying or used by any one or more of the methodologies or functions described herein. These instructions (e.g., the instructions 1012), when executed by processors 1006 cause various operations to implement the disclosed examples of the solutions.

The 1012 may be transmitted or received over the network 1024, using a transmission medium, via a network interface device (e.g., a network interface component included in the communication position components 1038) and using any one of several well-known transfer protocols (e.g., hypertext transfer protocol (HTTP)). Similarly, the instructions 1010 may be transmitted or received using a transmission medium via a coupling (e.g., a peer-to-peer coupling) to the devices 1026 or alternatively one or more Nodes 810 in a Distributed Ledger 816 system.

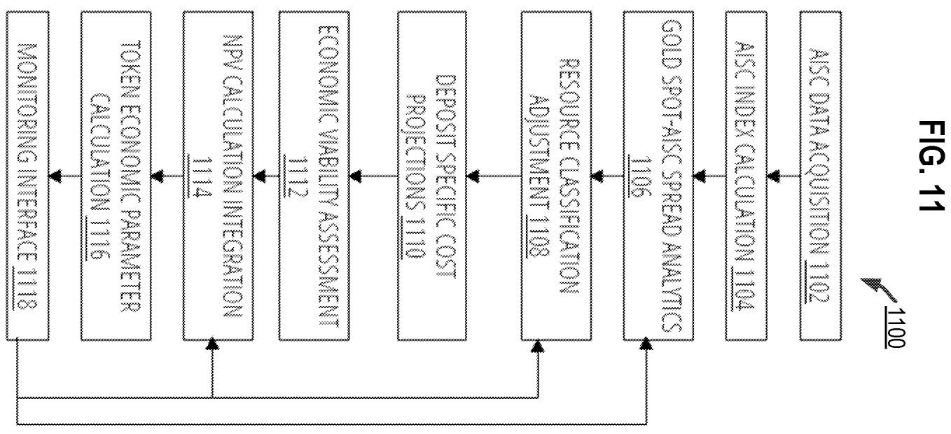

FIG. 11 illustrates an example method 1102 executable by an asset management system (e.g., asset management system 100 of FIG. 1) to transform verified gold deposits into tokenized digital assets through a comprehensive AISC-integrated workflow. In step 1102 ("AISC Data Acquisition"), the asset management system receives real-time cost reporting from global mining operations, aggregates production volumes and AISC figures by producer, and validates data integrity against financial statement references. In step 1104 ("AISC Index Calculation"), the asset management system applies volume-weighted averaging of validated AISC data, normalizes regional cost variations through currency adjustments, and generates the Real-Time AISC Index value. In step 1106 ("Gold Spot-AISC Spread Analytics"), the asset management system retrieves current gold spot price from market data feeds, calculates the differential between spot price and AISC Index, and determines the current global profit margin percentage.

In step 1108 ("Resource Classification Adjustment"), the asset management system applies base multipliers to resource categories (0.8/0.4/0.2), modifies multipliers based on current price-AISC spread, and produces adjusted resource valuation coefficients. In step 1110 ("Deposit Specific Cost Projections"), the asset management system analyzes technical factors for the specific deposit, estimates deposit-specific production costs relative to AISC Index, and generates production cost forecast over mine lifecycle. In step 1112 ("Economic Viability Assessment"), the asset management system compares deposit-specific costs against current and projected AISC, calculates extraction probability coefficients, and determines a viability score for tokenization eligibility.

In step 1114 ("NPV Calculation Integration"), the asset management system incorporates AISC-adjusted parameters into NPV model, applies jurisdiction-specific discount rates, and generates a final AISC-informed deposit valuation. In step 1116 ("Token Economic Parameter Calculation"), the asset management system determines token quantity based on AISC-adjusted NPV, establishes smart contract response thresholds for AISC fluctuations, and defines token value update protocols. In step 1118 ("Monitoring Interface"), the asset management system implements AISC index monitoring system, sets threshold triggers for value recalibration, and generates alerts for material changes in economic parameters. As changes drive updates to the AISC index, the asset management system propagates updates to step 1106 ("Gold Spot-AISC Spread Analytics"), step 1108 ("Resource Classification Adjustment"), and step 1114 ("NPV Calculation Integration") respectively.

According to embodiments, the asset management system 100 implements a real-time cost index generation pipeline that addresses technical challenges in aggregating, validating, and normalizing heterogeneous mining cost data from disparate sources into a unified, continuously updated index value. In an embodiment, the asset management system 100 receives a plurality of data feeds from external data sources, wherein the plurality of data feeds comprise portions of cost component data associated with gold mining production operations. According to embodiments, the asset management system 100 executes a multi-stage data validation process comprising: parsing incoming data feeds to extract production volume figures and per-ounce cost metrics from structured and semi-structured data formats; cross-referencing extracted cost data against corresponding financial statement references to detect inconsistencies or reporting anomalies; applying statistical outlier detection algorithms to identify and flag data points that deviate beyond a configurable threshold from historical reporting patterns for a given producer; and generating validated cost component data upon successful completion of the validation stages. According to embodiments, the asset management system 100 normalizes the validated cost component data by applying currency conversion algorithms that reference real-time foreign exchange rate feeds to convert regional cost figures into a standardized base currency, thereby generating normalized cost component data having a standardized data format. According to embodiments, the asset management system 100 calculates a weighted composite value based on the normalized cost component data, wherein each portion of cost component data from a respective mining producer is assigned a weighting factor proportional to that producer's reported production volume relative to total global production volume, such that the weighting factor represents the producer's relative contribution to total mining production costs. According to embodiments, the asset management system 100 generates the real-time cost index value (e.g., the Real-Time AISC Index value) based on the weighted composite value and stores the current cost index value in a database operatively coupled to the processing device, with the index value being updated at configurable intervals (e.g., upon receipt of new producer data or at periodic intervals such as every fifteen minutes) to maintain continuous alignment with current industry economics.

According to embodiments, the asset management system 100 deploys smart contracts that implement specific technical mechanisms for automated token value management and recalibration. In an embodiment, each smart contract deployed by the asset management system 100 includes executable code that defines one or more response threshold parameters corresponding to magnitude changes in the real-time cost index value. According to embodiments, the smart contract monitors incoming oracle data feeds carrying updated cost index values and, upon detecting that a change in the cost index value exceeds a configured response threshold, automatically executes a recalibration routine that adjusts the token's embedded valuation parameters. In an embodiment, the recalibration routine comprises: retrieving the current cost index value from an on-chain oracle contract; computing an updated spread between the current gold spot price and the updated cost index value; applying the updated spread to the resource classification multipliers associated with the token's underlying deposit to generate recalibrated valuation coefficients; updating the token's on-chain metadata to reflect the recalibrated valuation coefficients; and emitting a blockchain event log entry recording the recalibration trigger, the prior valuation parameters, and the updated valuation parameters. According to embodiments, the smart contract further implements rate-limiting logic that enforces a minimum time interval between successive recalibrations to prevent excessive on-chain state changes during periods of high cost index volatility. According to embodiments, the smart contract includes multi-signature validation gates that require cryptographic approval from a configurable number of authorized signatories (e.g., operational, technical, and compliance stakeholders) before executing recalibrations that exceed a predefined magnitude threshold, thereby providing a technical safeguard against erroneous or unauthorized valuation adjustments.

According to embodiments, the asset management system 100 provides specific technical improvements to distributed ledger-based digital asset management that enhance data processing efficiency, reduce computational overhead, and improve the accuracy of digital asset representations compared to conventional approaches. In an embodiment, the asset management system 100 addresses the technical problem of maintaining synchronized, real-time economic valuations across a distributed network of validating nodes by implementing an oracle-based data propagation architecture that reduces redundant data retrieval operations. According to embodiments, rather than requiring each validating node to independently query external data sources for cost index updates, the asset management system 100 employs a designated oracle node that retrieves, validates, and cryptographically signs cost index data, which is then propagated to the distributed ledger through a single consensus-validated transaction, thereby reducing network bandwidth consumption and computational load across the validating nodes. According to embodiments, the asset management system 100 further improves the technical functioning of the distributed ledger by implementing a hierarchical data storage architecture wherein frequently accessed token valuation parameters (e.g., current cost index reference values, recalibrated valuation coefficients) are maintained in an on-chain hot storage layer for rapid retrieval, while historical valuation records, audit trails, and supporting documentation references are stored in an off-chain content-addressable storage system with on-chain hash pointers ensuring data integrity. This hierarchical storage approach reduces on-chain storage requirements and improves transaction processing throughput compared to conventional blockchain implementations that store all asset-related data directly on-chain. According to embodiments, the asset management system 100 implements a batched transaction processing mechanism that aggregates multiple token recalibration operations triggered by a single cost index update into a consolidated blockchain transaction, reducing gas costs and improving processing efficiency relative to systems that execute individual transactions for each affected token.

According to embodiments, the asset management system 100 implements a technical pipeline for transforming raw mining operational data into actionable token valuation adjustments through a series of automated, machine-executed processing stages. In an embodiment, the asset management system 100 receives structured data transmissions from mining company reporting systems via secure API connections, wherein each data transmission includes production volume data, per-unit cost breakdowns across defined cost categories (e.g., mining costs, processing costs, sustaining capital expenditures, general and administrative costs), and metadata identifying the reporting entity and reporting period. According to embodiments, the asset management system 100 executes a data integrity verification process comprising: validating digital signatures associated with each data transmission to confirm the identity of the reporting entity; comparing reported figures against expected ranges derived from the reporting entity's historical data using statistical boundary checking algorithms; and reconciling reported production volumes against independently sourced production data where available. According to embodiments, upon successful verification, the asset management system 100 executes a volume-weighted aggregation algorithm that computes the weighted average cost per ounce across all reporting entities, with each entity's contribution weighted by its verified production volume. According to embodiments, the asset management system 100 further executes a deposit-specific cost projection module that analyzes technical parameters of a specific unmined gold deposit (e.g., ore grade, metallurgical recovery rates, strip ratios, processing method requirements) against the generated cost index to produce a deposit-specific production cost estimate. According to embodiments, the deposit-specific production cost estimate is compared against the current and projected cost index values to generate an economic viability score that quantifies the likelihood of economically viable extraction, which score is encoded into the corresponding token's smart contract as a machine-readable viability parameter that is automatically updated as the cost index changes.

According to embodiments, the asset management system (e.g., asset management system 100, 800 of FIGS. 1 and 8, respectively) is configured to perform a method for determining and tokenizing the value of verified unmined gold deposits, including: receiving, via a graphical user interface (GUI) into a server computer (e.g., a computing device of the asset management system), proof of title and ownership rights to at least one verified gold deposit in at least one specified location, along with documentation of unencumbered transfer of associated rights and interests; receiving, via the GUI into the server computer, resource verification documentation compliant with NI 43-101 or S-K 1300 standards for the verified gold deposit, including drill data, assay results, and geological models; accessing, via the server computer, a real-time All-In Sustaining Cost (AISC) index that provides a continuously updated weighted global average of gold production costs by incorporating the latest quarterly production and cost data as reported by individual mining companies; calculating, with the server computer, a net present value for the deposit by further comprising: applying resource classification multipliers of 0.8 for measured resources, 0.4 for indicated resources, and 0.2 for inferred resources; incorporating technical modifying factors including recovery rates, dilution, and processing costs; projecting operating costs and capital expenditures over the mine life relative to the real-time AISC index; forecasting revenue streams using commodity price projections; computing the expected margin between projected gold prices and the real-time AISC index over the projected mine life; applying jurisdiction-specific discount rates reflecting permitting and development timelines; determining, with the server computer, a total quantity of distributable tokens by dividing the calculated net present value by a standardized unit value, with the unit value derived from market comparable transactions for similar deposits and adjusted based on the current spread between gold market prices and the real-time AISC index; receiving, via the GUI into the server computer, validation of the value calculations from a qualified person as defined under NI 43-101 or S-K 1300; issuing, with the server computer, distributed ledger tokens representing fractional interests in the validated deposit value, with each token incorporating a smart contract that further comprises references to the underlying resource calculations, technical assumptions, and AISC index values; establishes mechanisms for value updates based on new technical data, changes in the AISC index, or market conditions; and defines token holder rights regarding value realization; recording the token issuance, underlying valuations, and current AISC index benchmark in a distributed ledger maintained across validating nodes; implementing, with the server computer, a continuous token value adjustment protocol that recalibrates token value based on periodic updates to the real-time AISC index, maintaining alignment between token value and current industry economics; and crediting the initial quantity of value-backed tokens to the titleholder's electronic wallet.

According to embodiments, the asset management system (e.g., asset management system 100, 800 of FIGS. 1 and 8, respectively) may include a server computer having a processor and memory; a graphical user interface (GUI) operatively coupled to the server computer; a distributed ledger network comprising a plurality of validating nodes; an electronic wallet interface operatively coupled to the server computer; and a real-time All-In Sustaining Cost (AISC) index database operatively coupled to the server computer, wherein the AISC index database provides a continuously updated weighted global average of gold production costs by incorporating the latest quarterly production and cost data as reported by individual mining companies. According to embodiments, the server computer is configured to: receive, via the GUI, proof of title and ownership rights to at least one verified gold deposit in at least one specified location, along with documentation of unencumbered transfer of associated rights and interests; receive, via the GUI, resource verification documentation compliant with NI 43-101 or S-K 1300 standards for the verified gold deposit, including drill data, assay results, and geological models; access the real-time AISC index database; calculate a net present value for the deposit by: applying resource classification multipliers of 0.8 for measured resources, 0.4 for indicated resources, and 0.2 for inferred resources; incorporating technical modifying factors including recovery rates, dilution, and processing costs; projecting operating costs and capital expenditures over the mine life relative to the real-time AISC index; forecasting revenue streams using commodity price projections; computing the expected margin between projected gold prices and the real-time AISC index over the projected mine life; and applying jurisdiction-specific discount rates reflecting permitting and development timelines; determine a total quantity of distributable tokens by dividing the calculated net present value by a standardized unit value, with the unit value derived from market comparable transactions for similar deposits and adjusted based on the current spread between gold market prices and the real-time AISC index; receive, via the GUI, validation of the value calculations from a qualified person as defined under NI 43-101 or S-K 1300; issue distributed ledger tokens representing fractional interests in the validated deposit value, with each token incorporating a smart contract that further comprises references to the underlying resource calculations, technical assumptions, and AISC index values; establishes mechanisms for value updates based on new technical data, changes in the AISC index, or market conditions; and defines token holder rights regarding value realization; record the token issuance, underlying valuations, and current AISC index benchmark in the distributed ledger maintained across the plurality of validating nodes; implement a continuous token value adjustment protocol that recalibrates token value based on periodic updates to the real-time AISC index, maintaining alignment between token value and current industry economics; and credit the initial quantity of value-backed tokens to the titleholder's electronic wallet via the electronic wallet interface.

According to embodiments, the server computer of the asset management system is further configured to: generate a visual representation of the relationship between the real-time AISC index and token value; display the visual representation on the GUI; and provide real-time alerts to token holders when the AISC index crosses predefined thresholds that trigger significant token value recalibrations.

According to embodiments, the asset management system (e.g., asset management system 100, 800 of FIGS. 1 and 8, respectively) may include a non-transitory computer-readable storage medium including instructions that when executed by a computer, cause the computer to execute operations including: storing proof of title and ownership rights documentation for at least one verified gold deposit in at least one specified location, wherein the documentation establishes unencumbered transfer of associated rights and interests; receiving resource verification documentation compliant with NI 43-101 or S-K 1300 standards for the verified gold deposit, wherein the documentation includes drill data, assay results, and geological models; accessing a real-time All-In Sustaining Cost (AISC) index database that provides a continuously updated weighted global average of gold production costs by incorporating the latest quarterly production and cost data as reported by individual mining companies; calculating a net present value for the deposit by executing valuation instructions that: apply resource classification multipliers of 0.8 for measured resources, 0.4 for indicated resources, and 0.2 for inferred resources to verified resource quantities; incorporate technical modifying factors comprising recovery rates, dilution factors, and processing costs derived from engineering studies; project operating costs and capital expenditures across the anticipated mine life relative to the real-time AISC index; forecast revenue streams using commodity price projections obtained from market data sources; compute the expected margin between projected gold prices and the real-time AISC index over the projected mine life; apply jurisdiction-specific discount rates that reflect permitting timelines and development schedules; determining a total quantity of distributable tokens by executing token generation instructions that divide the calculated net present value by a standardized unit value, wherein the unit value derives from a database of market comparable transactions for similar deposits and is adjusted based on the current spread between gold market prices and the real-time AISC index; verifying the value calculations through validation protocols that confirm qualified person approval as defined under NI 43-101 or S-K 1300 standards; generating distributed ledger tokens that represent fractional interests in the validated deposit value by executing smart contract instructions that: encode references to the underlying resource calculations, technical assumptions, and AISC index values; establish update mechanisms triggered by new technical data, changes in the AISC index, or market conditions; define parameters for token holder value realization rights; recording the token issuance, underlying valuations, and current AISC index benchmark in a distributed ledger through consensus mechanisms maintained across multiple validating nodes; implementing a continuous token value adjustment protocol that recalibrates token value based on periodic updates to the real-time AISC index, maintaining alignment between token value and current industry economics; and executing transfer instructions that credit the initial quantity of value-backed tokens to an electronic wallet associated with the titleholder.

The detailed description serves as an illustrative example, and it is not exhaustive of all potential implementation variants. Due to the impracticality of describing every conceivable blockchain solution—whether using current consensus mechanisms or those developed after this patent's filing—alternate configurations may exist that still fall within the scope of the claims.

Throughout this specification, references to singular instances of nodes, blocks, or transactions includes plural instances, and vice versa. Likewise, while blockchain operations are described separately, they can be performed concurrently or in a different sequence than presented. Components or functionalities described as separate in example configurations (such as mining and validation) may be combined, while those presented as a single entity may be divided into multiple components. These and other modifications or improvements to the blockchain architecture remain within the bounds of the described embodiments.

In certain implementation variants, blockchain logic, smart contracts, consensus algorithms, or cryptographic operations may be executed via software (e.g., code on a non-transitory, machine-readable medium) or hardware (e.g., specialized mining processors). In a hardware context, these operations can be physical, tangible units configured in specific ways, such as through application-specific integrated circuits (ASICs) or mining-specific processors. Alternatively, they may leverage general-purpose processors configured temporarily via software to execute specific blockchain operations. Decisions on whether to implement consensus mechanisms in dedicated hardware, software, or hybrid solutions may depend on energy efficiency, hash rate requirements, or other constraints.

For purposes of clarity, "blockchain node" should be understood to mean a tangible entity that can either be physically constructed or configured (permanently or temporarily) to operate in a specific manner within the network. If temporarily configured via software, a general-purpose processor may act as various types of nodes at different times. This flexibility enables the same processor to perform multiple functions dynamically, depending on the network's current needs.

Inter-node communication between blockchain participants may occur through peer-to-peer networks or other distributed systems. When nodes process blocks at different times, data can be stored and retrieved from distributed ledgers, enabling asynchronous operation. For instance, a mining node may execute a proof-of-work operation and broadcast its results to the network, allowing other nodes to validate and process the information later.

The operations of blockchain methods described in various implementation variants may be partially or fully implemented by one or more nodes. These nodes may be physically located within a single network or distributed across multiple systems, enabling decentralized processing. In some cases, these systems may be in a centralized pool, like a mining farm, while in other cases, they could be spread across multiple geographic locations. When nodes are distributed, they may communicate and coordinate their tasks via blockchain protocols, forming a cohesive network.

Terminology used herein, such as "mining," "validation," or "consensus," refers to the manipulation of data in cryptographic forms, such as hashes, digital signatures, or Merkle trees. When the specification refers to "one implementation variant" or "an implementation variant," it indicates that the described feature may be applicable to at least one possible blockchain solution. This should not imply that all instances of the phrase refer to the same implementation variant.

Additionally, terms like "comprises," "including," and their variants are intended to imply non-exclusive inclusion. For instance, a blockchain method that "comprises" certain elements is not limited to those elements alone and includes other components not explicitly listed. Similarly, "or" should be interpreted as inclusive unless otherwise specified, meaning proof-of-work or proof-of-stake could be implemented individually or in hybrid forms.

The descriptions provided are intended as illustrative, non-exhaustive examples of blockchain implementations. They do not define every possible implementation variant, as doing so would be impractical, if not impossible. Moreover, technological advancements in cryptography, consensus mechanisms, and alternate configurations may arise that still fall within the scope of the present disclosure.

What is claimed is:

1. A method comprising:
receiving, by a processing device via a graphical user interface, proof of title documentation for an unmined gold deposit;
receiving, via the graphical user interface, resource verification documentation compliant with at least one regulatory standard corresponding to the unmined gold deposit;
accessing a real-time cost index that provides an updated weighted average of gold production costs;
calculating a net present value associated with the unmined gold deposit based at least in part on the real-time cost index;
determining, based on the net present value, a total quantity of distributable tokens;
issuing, based on the total quantity of distributable tokens, a set of distributed tokens representing fractional interests of the net present value;
recording the issuing of the set of distributed tokens in a distributed ledger maintained across a plurality of validating nodes; and
transferring the set of distributed tokens to an electronic wallet associated with a titleholder.

2. The method of claim 1, wherein the real-time cost index comprises a real-time All-In Sustaining Cost (AISC) index that comprises production data and cost data received from one or more mining systems.

3. The method of claim 1, wherein the at least one regulatory standard comprises NI 43-101 or S-K 1300 standards.

4. The method of claim 1, wherein the resource verification documentation comprises one or more of drill data, assay results, or geological models.

5. The method of claim 1, wherein calculating the net present value comprises applying resource classification multipliers to one or more of a measured resource, an indicated resource, or inferred resource.

6. The method of claim 1, further comprising:
generating a visual representation of a relationship between the real-time cost index and token value; and
displaying the visual representation on the graphical user interface.

7. The method of claim 1, further comprising providing one or more alerts to one or more token holders in response to determining the real-time AISC index exceeds a threshold level.

8. A non-transitory computer-readable storage medium including instructions that when executed by a processing device, cause the processing device to perform operations comprising:
receiving, via a graphical user interface, proof of title documentation for an unmined gold deposit;
receiving, via the graphical user interface, resource verification documentation compliant with at least one regulatory standard corresponding to the unmined gold deposit;
accessing a real-time cost index that provides a continuously updated weighted average of gold production costs;
calculating a net present value associated with the unmined gold deposit based at least in part on the real-time cost index;
determining, based on the net present value, a total quantity of distributable tokens;
issuing, based on the total quantity of distributable tokens, a set of distributed tokens representing fractional interests of the net present value;
recording the issuing of the set of distributed tokens in a distributed ledger maintained across a plurality of validating nodes; and
transferring the set of distributed tokens to an electronic wallet associated with a titleholder.

9. The non-transitory computer-readable storage medium of claim 8, wherein the real-time cost index comprises a real-time All-In Sustaining Cost (AISC) index that comprises production data and cost data received from one or more mining systems.

10. The non-transitory computer-readable storage medium of claim 8, wherein the at least one regulatory standard comprises NI 43-101 or S-K 1300 standards.

11. The non-transitory computer-readable storage medium of claim 8, wherein the resource verification documentation comprises one or more of drill data, assay results, or geological models.

12. The non-transitory computer-readable storage medium of claim 8, wherein calculating the net present value comprises applying resource classification multipliers to one or more of a measured resource, an indicated resource, or inferred resource.

13. The non-transitory computer-readable storage medium of claim 8, the operations further comprising:
generating a visual representation of a relationship between the real-time cost index and token value; and
displaying the visual representation on the graphical user interface.

14. The non-transitory computer-readable storage medium of claim 8, the operations further comprising providing one or more alerts to one or more token holders in response to determining the real-time AISC index exceeds a threshold level.

15. A system comprising:
a memory to store instructions; and
a processing device operatively coupled to the memory, the processing device to execute the instructions to perform operations comprising:
receiving, via a graphical user interface, proof of title documentation for an unmined gold deposit;
receiving, via the graphical user interface, resource verification documentation compliant with at least one regulatory standard corresponding to the unmined gold deposit;
accessing a real-time cost index that provides a continuously updated weighted average of gold production costs;
calculating a net present value associated with the unmined gold deposit based at least in part on the real-time cost index;
determining, based on the net present value, a total quantity of distributable tokens;
issuing, based on the total quantity of distributable tokens, a set of distributed tokens representing fractional interests of the net present value;
recording the issuing of the set of distributed tokens in a distributed ledger maintained across a plurality of validating nodes; and
transferring the set of distributed tokens to an electronic wallet associated with a titleholder.

16. The system of claim 15, wherein the real-time cost index comprises a real-time All-In Sustaining Cost (AISC) index that comprises production data and cost data received from one or more mining systems.

17. The system of claim 15, wherein the resource verification documentation comprises one or more of drill data, assay results, or geological models.

18. The system of claim 15, wherein calculating the net present value comprises applying resource classification multipliers to one or more of a measured resource, an indicated resource, or inferred resource.

19. The system of claim 15, the operations further comprising:
generating a visual representation of a relationship between the real-time cost index and token value; and
displaying the visual representation on the graphical user interface.

20. The system of claim 15, the operations further comprising providing one or more alerts to one or more token holders in response to determining the real-time AISC index exceeds a threshold level.
